(19) United States
(12) Patent Application Publication
(10) Pub. No.: US 2011/0096071 A1
(43) Pub. Date: Apr. 28, 2011

(54) STEREOSCOPIC IMAGE DISPLAY DEVICE AND DRIVING METHOD OF THE SAME

(75) Inventors: Yoshiki Okamoto, Kanagawa (JP); Yutaka Imai, Tokyo (JP); Yoshihisa Sato, Saitama (JP); Miki Tsuchiya, Kanagawa (JP)

(73) Assignee: SONY CORPORATION, Tokyo (JP)

(21) Appl. No.: 12/909,553

(22) Filed: Oct. 21, 2010

(30) Foreign Application Priority Data
Oct. 28, 2009 (JP) P2009-247480

(51) Int. Cl. G06T 15/00

(52) U.S. Cl. 345/419

(57) ABSTRACT

An image display device includes an image display section and a lenticular lens including a plurality of lenses arranged in a linear array. Each lens is defined by a plurality of adjacent variable lenses having a common optical axis. The image display device also includes a controller that controls optical characteristics in a plurality of the variable lenses such that the common optical axis for at least one of the lenses is moved in a given direction.

### CROSS REFERENCES TO RELATED APPLICATIONS

The present application claims priority to Japanese Patent Application JP 2009-247480 filed on Oct. 28, 2009, the entire contents of which is hereby incorporated by reference.

### BACKGROUND

The present disclosure relates to a stereoscopic image display device and driving method of the same and more particularly to a so-called lenticular stereoscopic image display device and driving method of the same.

A variety of naked-eye binocular stereoscopic image display devices are known that permit stereoscopic viewing as the image observer observes two images having parallax. Energetic efforts are being made toward the commercialization of a lenticular stereoscopic image display device among the above display devices. A lenticular stereoscopic image display device is a combination of an image display section (two-dimensional image display device) such as liquid crystal display device and a lenticular lens. Here, the lenticular lens is made up of a plurality of cylindrical lenses arranged side by side. The lenticular lens and image display device are arranged so that the focal plane of the cylindrical lenses matches the display surface of the image display section. The simplest of all arrangements of the image display section and lenticular lens is that in which the two are arranged so that the axial lines of the lenses and the vertical direction of the image display section are parallel.

Incidentally, the image display section normally includes a plurality of pixels arranged horizontally and vertically in a two-dimensional matrix. A cylindrical lens is arranged for a given number of horizontally arranged pixels. The lenticular lens allows for light beams emitted from a group of pixels adapted to display, for example, “A” (pixels belonging to this group are denoted by “1” in FIG. 17) to form an image at a first viewpoint (space ‘a’), as illustrated in a conceptual diagram in FIG. 17. On the other hand, the lenticular lens allows for light beams emitted from a group of pixels adapted to display, for example, “B” (pixels belonging to this group are denoted by “2” in FIG. 17) to form an image at a second viewpoint (space ‘b’). It should be noted that although the group of light beams denoted by solid or dashed-and-dotted lines reaches the space ‘a’ or ‘b,’ that of light beams denoted by dotted lines do not do so. Assuming that the left and right eyes of the image observer are located respectively at the spaces ‘a’ and ‘b,’ the image observer can perceive the appropriate images “A” and “B” as stereoscopic images when these images are displayed simultaneously on the image display section. Here, two viewpoints are obtained in the example shown in FIG. 17 because the images “A” and “B” are displayed at the same time on the image display section. In general, when N_{POV} different images are displayed on the image display section, N_{POV} viewpoints are obtained.

A stereoscopic image display device is known, for example, from JP-T-2006-521572 and JP-T-2008-529045 (hereinafter referred to as Patent Documents 1 and 2, respectively) that includes a lenticular lens made of a liquid lens using electrowetting.

Here, the term “electrowetting” is a phenomenon in which when a voltage is applied between a conductive liquid and an electrode, the energy at the solid-liquid interface between the electrode surface and liquid changes, changing the shape of the liquid surface. FIGS. 18A and 18B are diagrams illustrating the working principle behind electrowetting. As schematically illustrated in FIG. 18A, we assume that an insulating film 102 is formed on the surface of an electrode 101, and that a conductive liquid droplet 103 made of an electrolytic solution is on the insulating film 102. The surface of the insulating film 102 is treated to be water-repellent. When no voltage is applied as illustrated in FIG. 18A, the interaction energy between the surface of the insulating film 102 and the liquid droplet 103 is low with a large contact angle θ₀. Here, the contact angle θ₀ is the angle formed between the surface of the insulating film 102 and the tangent of the liquid droplet 103 and depends upon the physical properties including the surface tension of the liquid droplet 103 and the surface energy of the insulating film 102.

As illustrated in FIG. 18B, on the other hand, when a voltage is applied between the electrode 101 and liquid droplet 103, the electrolyte ions of the liquid droplet concentrate on the surface of the insulating film 102, changing the amount of charge carried by a charge double layer and thereby inducing the change in the surface tension of the liquid droplet 103. This phenomenon is electrowetting and changes a contact angle θ_{V} of the liquid droplet 103 depending on the applied voltage. That is, the contact angle θ_{V} in FIG. 18B is expressed as a function of an applied voltage V by the Lippman-Young equation given below as Equation A.

cos(θ_{V})=cos(θ₀)+(½)(ε₀·ε)/(γ_{LG}·t)×V² (A)

where

ε₀: Dielectric constant of vacuum

ε: Specific dielectric constant of the insulating film

γ_{LG}: Surface tension of the electrolytic solution

t: Thickness of the insulating film

As described above, the surface shape (curvature) of the liquid droplet 103 changes depending on the voltage V applied between the electrode 101 and liquid droplet 103. Therefore, using the liquid droplet 103 as a lens element provides an optical element capable of electrically controlling the focal point (focal distance).

### SUMMARY

The number of viewpoints must be increased to expand the spatial region in which stereoscopic viewing is possible in a lenticular stereoscopic image display device. As described above, however, the N_{POV} different images must be displayed on the image display section to obtain the N_{POV} viewpoints. This leads to lower resolution of the stereoscopic image as a result of increased number of viewpoints.

However, no means for solving this problem are disclosed in the above Patent Documents 1 and 2.

Means for solving the problem is disclosed, for example, in Japanese Patent Laid-open No. 2009-048116 (hereinafter referred to as Patent Document 3). The stereoscopic image display device disclosed in this Patent Document 3 includes displacement means. The displacement means causes at least either the lenticular lens or image display section to make a reciprocating motion in the plane parallel (approximately parallel) to the display surface of the image display section. This mechanically and periodically changes the position of each of the cylindrical lenses relative to each of the pixels of the image display section, thus periodically displacing the direction in which the display image light from an arbitrary pixel is emitted by each cylindrical lens. This technique is excellent for solving the problem of reduced resolution of the stereoscopic image caused by the increased number of viewpoints. However, because the displacement means includes mechanical displacement means, and more particularly, a piezoelectric element, it is difficult to quickly control the periodical displacement of each of the cylindrical lenses relative to each of the pixels of the image display section. Further, it is difficult to meet the demand for higher reliability and permit application to a larger stereoscopic image display device.

In an embodiment, an image display device includes an image display section and a lenticular lens including a plurality of lenses arranged in a linear array. Each lens is defined by a plurality of adjacent variable lenses having a common optical axis. The image display device also includes a controller that controls optical characteristics in a plurality of the variable lenses such that the common optical axis for at least one of the lenses is moved in a given direction.

In an embodiment, a method of displaying images includes: displaying images on an image display device; controlling optical characteristics of a plurality of lenses such that the plurality of lenses form a lenticular lens, each of said lenses having a common optical axis and including a plurality of adjacent variable lenses; and changing the optical characteristics of a plurality of the variable lenses such that the common optical axis for at least one of the lenses is moved in a given direction.

In one embodiment, an optical device includes: a plurality of variable lenses arranged in a linear array, each lens being defined by a plurality of adjacent variable lenses having a common optical axis; and a controller that controls optical characteristics in a plurality of the lenses such that the common optical axis for at least one of the lenses is moved in a given direction.

In one embodiment, a method of controlling an optical device including a plurality of variable lenses includes: controlling optical characteristics of a plurality of variable lenses such that a plurality of adjacent variable lenses form a lens having a common optical axis; and changing the optical characteristics of the plurality of the variable lenses such that the common optical axis of the lens is moved in a given direction.

In one embodiment, a stereoscopic image display device includes: an image display section; a lenticular lens including a plurality of liquid lenses arranged in a linear array; and a controller that controls shapes of liquid-liquid interfaces of the liquid lenses such that a first liquid-liquid interface shape is sequentially formed in a plurality of adjacent liquid lenses in a given direction of the linear array. In this embodiment, the liquid-liquid interface shape is sequentially formed in synchronization with a switching of image frames of the image display section.

In one embodiment, a method of stereoscopically displaying images includes: displaying images on an image display device; and controlling shapes of liquid-liquid interfaces in a plurality of liquid lenses arranged in a linear array to sequentially form a first liquid-liquid interface shape in a plurality of adjacent liquid lenses in a given direction of the linear array. In this embodiment, the liquid-liquid interface shape is sequentially formed in synchronization with a switching of image frames of the image display section.

In one embodiment, a stereoscopic image display device includes: an image display section; a plurality of liquid lens compartments arranged in a linear array, each liquid lens compartment including a plurality of walls that contain first and second liquids, the first liquid being immiscible with the second liquid, first, second and third electrodes positioned on the walls of the compartment; and a controller for applying, to one of the liquid lens compartments, a first electric potential to the first electrode and a second electric potential to the second electrode to form a shape of an interface between the first and second liquids. In this embodiment, the controller applies electric potentials to first and second electrodes of each of a plurality of different liquid lens compartments in a given direction of the linear array to sequentially form said shape of the interface in said different liquid lens compartments. Also, forming the shape of the interface in the different liquid lens compartments is performed in synchronization with a switching of image frames of the image display section.

In light of the foregoing, it is desired to provide a stereoscopic image display device and driving method of the same that permits observation of a stereoscopic image in a large spatial region without using any mechanical means and that also permits ready display of a high-definition stereoscopic image.

Additional features and advantages are described herein, and will be apparent from the following Detailed Description and the figures.

### BRIEF DESCRIPTION OF THE FIGURES

FIGS. 1A and 1B are a conceptual diagram of a stereoscopic image display device according to an embodiment 1 and a schematic partial cross-sectional view of a lenticular lens section, respectively;

FIGS. 2A to 2C are schematic partial cross-sectional views of the manner in which optical axes of cylindrical lenses making up the lenticular lens section of the stereoscopic image display device according to embodiment 1 move in the X direction;

FIG. 3 is a block diagram illustrating the overall configuration of the stereoscopic image display device according to embodiment 1;

FIG. 4 is a diagram for describing the kinds of images obtained at different viewpoints when the optical axes of the cylindrical lenses making up the lenticular lens section are moved in the X direction in the stereoscopic image display device according to embodiment 1;

FIG. 5 is a diagram continued from FIG. 4 for describing the kinds of images obtained at different viewpoints when the optical axes of the cylindrical lenses making up the lenticular lens section are moved in the X direction in the stereoscopic image display device according to embodiment 1;

FIG. 6 is a diagram continued from FIG. 5 for describing the kinds of images obtained at different viewpoints when the optical axes of the cylindrical lenses making up the lenticular lens section are moved in the X direction in the stereoscopic image display device according to embodiment 1;

FIG. 7A is a schematic cross-sectional view of a lens compartment taken along arrow A-A in FIG. 7B, FIG. 7B a schematic cross-sectional view of the lens compartment taken along arrow B-B in FIG. 7A, and FIG. 7C a schematic cross-sectional view of the lens compartment taken along arrow C-C in FIG. 7A;

FIGS. 8A to 8C are schematic cross-sectional views of the lens compartment taken along arrow C-C in FIG. 7A schematically describing the working principle behind a liquid lens;

FIG. 9 is a similar schematic cross-sectional view of part of the lenticular lens section according to embodiment 1 taken along arrow A-A in FIG. 7B;

FIGS. 10A to 10C are schematic cross-sectional views of part of the lenticular lens section according to embodiment 1 taken along arrow C-C in FIG. 9 schematically describing the behavior of the liquid lens;

FIGS. 11A to 11C are similar schematic cross-sectional views of part of the lenticular lens section according to embodiments 2, 3 and 4 taken along arrow C-C in FIG. 9 schematically describing the behavior of the liquid lens;

FIG. 12 is a block diagram illustrating the overall configuration of the stereoscopic image display device according to embodiment 5;

FIG. 13 is a schematic diagram for describing the relationship between a pixel pitch, viewpoint-to-viewpoint distance and cylindrical lens pitch;

FIG. 14 is a conceptual diagram of the lenticular lens section of the stereoscopic image display device according to embodiment 6;

FIG. 15 is a conceptual diagram for describing the arrangement of the lenticular lens section, image display section and other components of the stereoscopic image display device according to embodiment 7;

FIG. 16 is a conceptual diagram for describing the arrangement of the lenticular lens section, image display section and other components of a modification example of the stereoscopic image display device according to embodiment 7;

FIG. 17 is a conceptual diagram of a lenticular stereoscopic image display device in related art; and

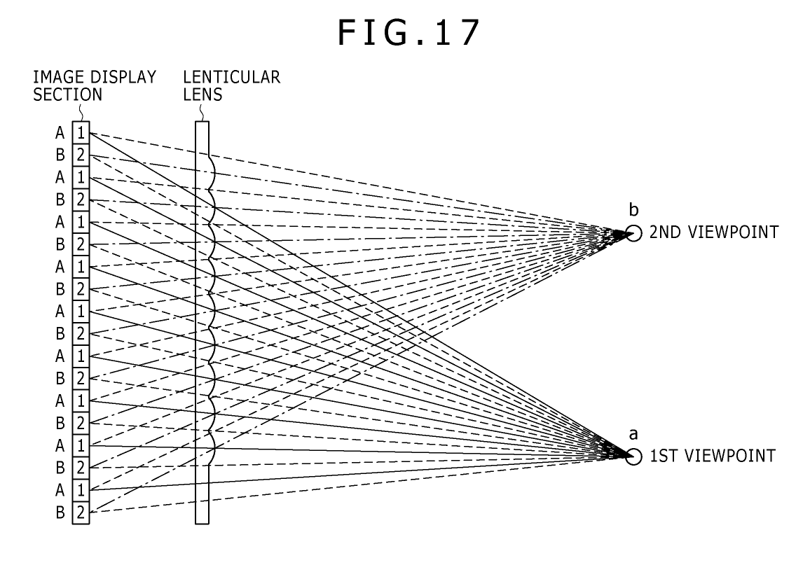

FIGS. 18A and 18B are working principle diagrams for describing electrocapillarity.

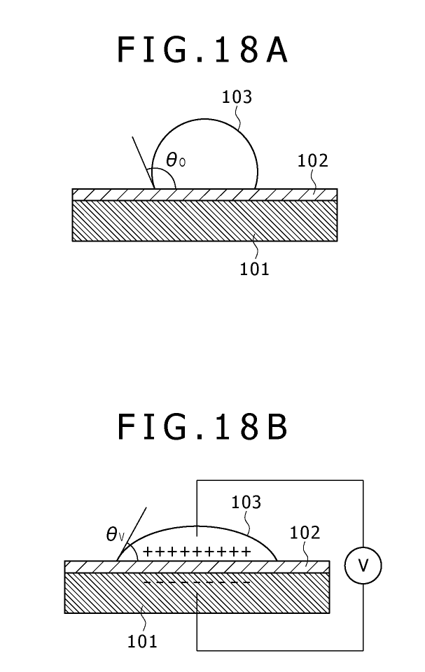

### DETAILED DESCRIPTION

Therefore, the values and materials used in the following embodiments are merely illustrative. The description will be given in the following order:
1. Description in general of the stereoscopic image display device and driving method of the same
2. Embodiment 1 (stereoscopic image display device and driving method of the same)
3. Embodiment 2 (modification of embodiment 1)
4. Embodiment 3 (another modification of embodiment 1)
5. Embodiment 4 (still another modification of embodiment 1)
6. Embodiment 5 (still another modification of embodiment 1)
7. Embodiment 6 (still another modification of embodiment 1)
8. Embodiment 7 (still another modification of embodiment 1 and others)

[Description in General of the Stereoscopic Image Display Device and Driving Method of the Same]

In the stereoscopic image display device according to an embodiment, the application of voltages to the electrodes in each of the lens compartments should preferably be controlled to move the optical axes of the cylindrical lenses in the X direction in synchronism with switching between image frames on the image display section. Further, in the driving method of a stereoscopic image display device according to the embodiment, the optical axes of the cylindrical lenses should preferably be moved in the X direction in synchronism with switching between image frames on the image display section.

In the stereoscopic image display device or driving method of a stereoscopic image display device according to the embodiment including the above preferred embodiments, the arrangement pitch of the cylindrical lenses can be changed by controlling the application of voltages to the electrodes in each of the lens compartments. In this case, the stereoscopic image display device or the like should preferably be able to change the viewing distance by changing the arrangement pitch of the cylindrical lenses. Further, the stereoscopic image display device or the like should preferably include a position measuring section and control the application of voltages to the electrodes in each of the compartments based on the position information of the image observer obtained from the position measuring section. This configuration contributes to an optimal observation (viewing) region of a stereoscopic image. Because each of the cylindrical lenses includes a Fresnel lens made up of a plurality of consecutive lens compartments, the arrangement pitch of the cylindrical lenses can be readily changed by controlling the application of voltages to the electrodes in each of the lens compartments. Among devices that can be used as a position measuring section are video camcorder or web camera having a solid-state imaging element capable of capturing a still or moving image and infrared position measuring device. Here, the term “viewing distance” refers to the distance from the lenticular lens section to the image observer when the lenticular lens section faces the image observer and to the distance from the image display section to the image observer when the image display section faces the image observer.

In the stereoscopic image display device or the like including the above various preferred modes and configurations, a lens compartment (hereinafter referred to as a “boundary lens compartment” for reasons of convenience) can be provided between the cylindrical lenses. Controlled by the lens control section, the boundary lens compartment has optical power opposite in sign to that of the cylindrical lenses. This prevents light passing through the boundary lens compartment from reaching the image observer, thus making it difficult for the image observer to visually perceive the boundary region between the cylindrical lenses and thereby providing improved quality of the displayed image. The number of boundary lens compartments needs only be one or two or more. Here, if the cylindrical lenses serve as convex lenses, the boundary lens compartment need only serve as a concave lens. On the other hand, if the cylindrical lenses serve as concave lenses, the boundary lens compartment need only serve as a convex lens.

Further, the stereoscopic image display device or the like including the above various preferred modes and configurations may include a light source so that the light source, image display section and lenticular lens section are arranged in this order. Alternatively, the light source, lenticular lens section and image display section may be arranged in this order. In the former case, the cylindrical lenses need only serve as convex lenses. In the latter case, on the other hand, the cylindrical lenses need only serve as convex or concave lenses. In these cases, the image display section may include, for example, a liquid crystal display device, and the light source a so-called backlight. However, the stereoscopic image display device according to the present embodiment is not limited to these configurations. A self-luminous image display device, and more particularly an organic electroluminescence or plasma display device, for example, may be used as the image display section.

Still further, in the stereoscopic image display device or the like according to the embodiment including the above various preferred modes and configurations, the lenticular lens section may include
(A) a housing, and
(B) (M−1) partition wall members.

The housing includes first, second, third and fourth side members. The second side member is opposed to the first side member. The third side member connects one end portion of the first side member and one end portion of the second side member. The fourth side member connects the other end portion of the first side member and the other end portion of the second side member.

The housing further includes a ceiling plate attached to the top surfaces of the first, second, third and fourth side members.

The housing still further includes a bottom plate attached to the bottom surfaces of the first, second, third and fourth side members.

The (M−1) partition wall members are arranged parallel to each other between the first and second side members.

M lens compartments are arranged side by side.

(a) The first lens compartment includes the first and third side members, first partition wall member, fourth side member, ceiling plate and bottom plate. A first electrode is provided on the inner surface of the ceiling plate making up the first lens compartment. A second electrode is provided on the inner surface of the first side member making up the first lens compartment. A third electrode is provided on the inner surface of the first partition wall member making up the first lens compartment.

(b) The (m+1)th lens compartment includes the mth (where m=1, 2, . . . M−2) partition wall member, third side member, (m+1)th partition wall member, fourth side member, ceiling plate and bottom plate. The first electrode is provided on the inner surface of the ceiling plate making up the (m+1)th lens compartment. The second electrode is provided on the inner surface of the mth partition wall member making up the (m+1)th lens compartment. The third electrode is provided on the inner surface of the (m+1)th partition wall member making up the (m+1)th lens compartment.

(c) The Mth lens compartment includes the (M−1)th partition wall member, third side member, second side member, fourth side member, ceiling plate and bottom plate. The first electrode is provided on the inner surface of the ceiling plate making up the Mth lens compartment. The second electrode is provided on the inner surface of the (M−1)th partition wall member making up the Mth lens compartment. The third electrode is provided on the inner surface of the second side member making up the Mth lens compartment. The lenticular lens section having this configuration is referred to as an “M lens compartment structure lenticular lens section” for reasons of convenience.

In the M lens compartment structure lenticular lens section, the surfaces of at least the first and second side members and partition wall members, where the interfaces between the first and second liquids are located, should preferably be treated to be water-repellent. The optical axes of the cylindrical lenses can be moved in the X direction by changing the voltages applied to the second and third electrodes in each of the lens compartments. Among water-repellent treatment methods are the formation of polyparaxylylene by CVD (Chemical Vapor Deposition) and the coating of a fluorine-based polymer such as PVDF (polyvinylidene fluoride) and PTFE (polytetrafluoroethylene). The surfaces of at least the first and second side members and partition wall members, where the interfaces between the first and second liquids are located, may be coated with a layered structure made up of a combination of a plurality of high dielectric constant material and water-repellent material. Alternatively, the surfaces of at least outer wall member and partition wall members, where the interfaces between the first and second liquids is located, may be coated with the layered structure.

In the M lens compartment structure lenticular lens section, the bottom surfaces of the partition wall members can extend to the bottom plate, and the top surfaces of the partition wall members to the ceiling plate. This configuration is referred to as an “Ath configuration” for reasons of convenience. Here, the term “top surfaces of the partition wall members” refers to the surfaces opposed to the ceiling plate and the term “bottom surfaces of the partition wall members” refers to the surfaces opposed to the bottom plate. This is also true in the description that follows. Alternatively, the bottom surfaces of the partition wall members can extend to the bottom plate, with a gap provided between the top surfaces of the partition wall members and the ceiling plate. It should be noted that this configuration is referred to as a “Bth configuration” for reasons of convenience. Still alternatively, a gap can be provided between the bottom surfaces of the partition wall members and the bottom plate, with the top surfaces of the partition wall members extending to the ceiling plate. This configuration is referred to as a “Cth configuration” for reasons of convenience. Still alternatively, a gap can be provided between the bottom surfaces of the partition wall members and the bottom plate, and another gap between the top surfaces of the partition wall members and the ceiling plate. This configuration is referred to as a “Dth configuration” for reasons of convenience. It should be noted that, in the Dth configuration, the partition wall members need only be fastened to the outer wall member, bottom plate, ceiling plate or the like in an appropriate manner.

In the present embodiment, the first and second liquids should preferably be insoluble and immiscible with each other. Further, in the M lens compartment structure lenticular lens section, the first liquid can be conductive, and the second liquid insulating. The first electrode can be in contact with the first liquid. The second electrode can be in contact with the first and second liquids via an insulating film. The third electrode can be in contact with the first and second liquids via an insulating film. On the other hand, the ceiling and bottom plates and first electrode should preferably be made of a material transparent to light incident upon the lenticular lens section.

Among conductive liquids (or polar liquids; hereinafter may be collectively referred to as conductive liquids) are water, electrolytic solutions (aqueous solutions of electrolytes such as potassium chloride, sodium chloride, lithium chloride and sodium sulfate), aqueous solutions with any of these electrolytes dissolved therein such as aqueous solution of triethylene glycol, alcohols having a small molecular weight such as methyl and ethyl alcohols, room temperature molten salt (ionic liquids), polar liquids such as pure water, and mixtures of these liquids. Alcohols such as methyl and ethyl alcohols need only be made conductive for use by making them into an aqueous solution or dissolving salt therein. On the other hand, among insulating liquids (or nonpolar liquids; hereinafter may be collectively referred to as insulating liquids) are nonpolar solvents including hydrocarbon-based materials such as decane, dodecane, hexadecane and undecane, silicone oil and fluorine-based materials. Conductive and insulating liquids must have different refractive indices and be able to coexist without mixing. The conductive and insulating liquids should preferably have the same density to the extent possible. Although the conductive and insulating liquids should preferably be transparent to light incident upon the lenticular lens section (referred to as incident light), they may be colored in some cases.

In the M lens compartment structure lenticular lens section, the members (more specifically, at least the ceiling and bottom plates) through which incident light passes may be required to be made of a material transparent to incident light. The term “transparent to incident light” refers to the fact that the transmittance of incident light is 80% or greater. Among materials that can be used to pass incident light are acryl-based resins, polycarbonate resins (PC), ABS resins, poly(methyl methacrylate) (PMMA), polyarylate resins (PAR), polyethylene terephthalate resins (PAR) and glass. The members through which incident light passes may be made of the same material or different materials. Light may enter the lenticular lens section from the ceiling plate and leave the same section from the bottom plate. Alternatively, light may enter the lenticular lens section from the bottom plate and leave the same section from the ceiling plate.

Depending on the location and required properties, the electrodes can be made of transparent materials such as indium-tin oxides (ITOs including Sn-doped In₂O₃, crystalline ITO, amorphous ITO and silver-added ITO), indium-zinc oxides (IZOs), In₂O₃-based materials (including IFO which is F-doped In₂O₃), tin oxides (including ATO which is Sb-doped SnO₂ and FTO which is F-doped SnO₂), zinc oxide-based materials (ZnOs, including Al-doped ZnO, B-doped ZnO and Ga-doped ZnO), Sb₂O₅-based materials, In₄Sn₃O₁₂, InGaZnO, titanium oxide (TiO₂), spinel oxides, conductive metal oxides such as oxides having YbFe₂O₄ structure, metals, alloys and semiconductor materials. Alternatively, the electrodes can be made of opaque materials such as metals and alloys. More specifically, among materials that can be used as the electrodes are: metals such as aluminum (Al), tungsten (W), niobium (Nb), tantalum (Ta), molybdenum (Mo), chromium (Cr), copper (Cu), gold (Au), silver (Ag), titanium (Ti), nickel (Ni), cobalt (Co), zirconium (Zr), iron (Fe), platinum (Pt) and zinc (Zn); alloys containing these metal elements (e.g., MoW), or containing these metal elements (e.g., nitride such as TiN and silicides such as WSi₂, MoSi₂, TiSi₂ and TaSi₂); semiconductors such as silicon (Si); and carbon thin film such as diamond. Among methods used to form these electrodes are: vapor deposition methods such as electron beam vapor deposition and hot filament vapor deposition, sputtering, CVD, combination of sputtering, CVD or ion plating and etching; screen printing; plating (electric and electroless plating); liftoff; laser abrasion and Sol-Gel method.

The insulating film is not specifically limited in material so long as it is made of an electrically insulating material. A material having a relatively high specific dielectric constant is preferably chosen. On the other hand, although a thin insulating film is preferred to obtain relatively large electrostatic capacitance, the insulating film must be thick enough to provide the required insulation strength. Among materials that can be used as the insulating film are SiOₓ materials and SiN, SiO₂-based materials such as SiON, silicon oxide fluoride, polyimide resins, SOG (Spin-On-Glass), low-melting glass and glass paste, titanium oxide (TiO₂), tantalum oxide (Ta2O₅), aluminum oxide (Al₂O₃), magnesium oxide (MgO), chromium oxide (CrOₓ), zirconium oxide (ZrO₂), niobium oxide (Nb₂O₅), tin oxide (SnO₂) and vanadium oxide (VOₓ). Among methods used to form the insulating film are publicly known processes such as CVD, coating, sputtering, screen printing, plating, electro-deposition and immersion.

In the M lens compartment structure lenticular lens section, the distance between the partition wall members along the X direction or that between the outer wall member and first or (M−1)th partition wall member along the X direction for the lens compartments may be the same for all the lens compartments or different from one lens compartment to another. The distance between the second and third electrodes along the X direction for the lens compartments (or that between the partition wall members along the X direction or that between the outer wall member and first or (M−1)th partition wall member along the X direction) should preferably be set to a capillary length κ⁻¹ or less. Here, the term “capillary length κ⁻¹” refers to the maximum length within which the impact of gravity on interfacial tension can be ignored. More specifically, the capillary length κ⁻¹ can be expressed by the following Equation B where the interfacial tension between the conductive and insulating liquids is Δγ and the difference in density between the two liquids Δρ and the gravitational acceleration g:

κ⁻¹={Δγ/(Δρ·g)}^{1/2} (B)

The following summarizes what each of symbols M, N_{CL}, N_{LC-unit}, N_{POV}, Nₚₓ and N_{unit-TL} represents. It should be noted that the term “pixel subunit” (described in detail later) in the stereoscopic image display device according to embodiments corresponds to a ‘pixel’ in a common two-dimensional image display device, and the term “pixel” in the stereoscopic image display device according to the embodiments to a ‘subpixel’ in a common two-dimensional image display device.
M: Number of lens compartments
Nᵤ: Number of cylindrical lenses
N_{LC-unit}: Number of lens compartments making up a single cylindrical lens
N_{POV}: Number of viewpoints
Nₚₓ: Number of pixels making up a pixel subunit (described later)
N_{unit-TL}: Number of pixel units arranged horizontally in the image display device

In the stereoscopic image display device or the like according to embodiments including the above various preferred modes and configurations, a cylindrical lens (Fresnel lens) is made up of a plurality of consecutive lens compartments. Here, when N_{LC-unit} denotes the number of consecutive lens compartments (number of lens compartments making up a single cylindrical lens), N_{LC-unit} may be 2≦N_{LC-unit}≦30, and more preferably 5≦N_{LC-unit}≦20.

It should be noted that N_{CL}×N_{LC-unit}≦M. Here, if no boundary lens compartments are provided, M=N_{CL}×N_{LC-unit}. On the other hand, when boundary lens compartments are provided, the number of boundary lens compartments is given by (M−N_{CL}×N_{LC-unit}).

On the other hand, when the number of pixels making up each of the pixel subunits arranged horizontally in the image display section is denoted by Nₚₓ, each of the pixel subunits can include, for example, three types of pixels, i.e., red, green and blue pixels (the number of pixels is, for example, three with one red, one green and one blue pixels; Nₚₓ=3). Alternatively, each pixel subunit can include, for example, four pixels with one red pixel, two green pixels and one blue pixel (Nₚₓ=4). Still alternatively, each pixel subunit can include, for example, four or more types of pixels in addition to the three different pixels including those pixels adapted to emit white light for improved brightness, complementary color light for a wider color reproduction range, yellow light for a wider color reproduction range and yellow and cyan light for a wider color reproduction range. As the possible numbers of pixel subunits Nₚₓ arranged horizontally and vertically in the image display section, some examples of image display resolution can be cited including not only VGA (640, 480), S-VGA (800, 600), XGA (1024, 768), APRC (1152, 900), S-XGA (1280, 1024), U-XGA (1600, 1200), HD-TV (1920, 1080), Q-XGA (2048, 1536) but also (1920, 1035), (720, 480), (854, 480), (1280, 960), (4096, 2160) and (3840, 2160). However, the possible numbers of pixel subunits Nₚₓ are not limited to the above.

The N_{POV} different images must be displayed on the image display section to obtain the N_{POV} viewpoints. However, N_{POV} need only be two or greater. In order to display the N_{POV} different images on the image display section, each pixel unit is made up of N_{POV} subunits. The number of pixels making up a single pixel unit is N_{POV}×N. Here, when the number of pixel units arranged horizontally in the image display section is denoted by N_{unit-TL}, the value of N_{unit-TL} corresponds to the horizontal resolution of the image display section (horizontal resolution of the stereoscopic image display device), and the total number of pixels arranged horizontally in the image display section is given by N_{unit-TL}×N_{POV}×Nₚₓ. The number of lens compartments per pixel is 0.25 to four, and preferably 0.5 to two.

N_{LC-unit} may be constant or variable depending on the position occupied by the cylindrical lens. On the other hand, the optical surface included in the XZ plane obtained when the cylindrical lens is cut along the YZ plane passing through the center of the cylindrical lens may be symmetrical with respect to the YZ plane or asymmetrical with respect thereto in some cases. The X direction may be parallel to the horizontal direction of the image display section or be inclined relative thereto at a given angle. When the lenticular lens section faces the image observer, the lenticular lens section and image display section should preferably be arranged so that the focal plane of the cylindrical lenses matches the display surface of the image display section. However, the present embodiment is not limited thereto. On the other hand, when the image display section faces the image observer and the cylindrical lenses serve as convex lenses, the lenticular lens section and image display section should preferably be arranged so that the distance from the cylindrical lenses to the display surface of the image display section is twice the focal distance of the cylindrical lenses. When the cylindrical lenses serve as concave lenses, the lenticular lens section and image display section should preferably be arranged so that the distance from the cylindrical lenses to the display surface of the image display section matches the focal distance of the cylindrical lenses. However, the present embodiment is not limited thereto. Although each cylindrical lens is made up of a plurality of consecutive lens compartments, and part of a Fresnel lens is made up of each lens compartment, the shape of part of the “Fresnel lens” may be referred to as a kinoform shape. Among possible types of arrangement of the pixels are striped, diagonal, delta and rectangle arrangements.

### Embodiment 1

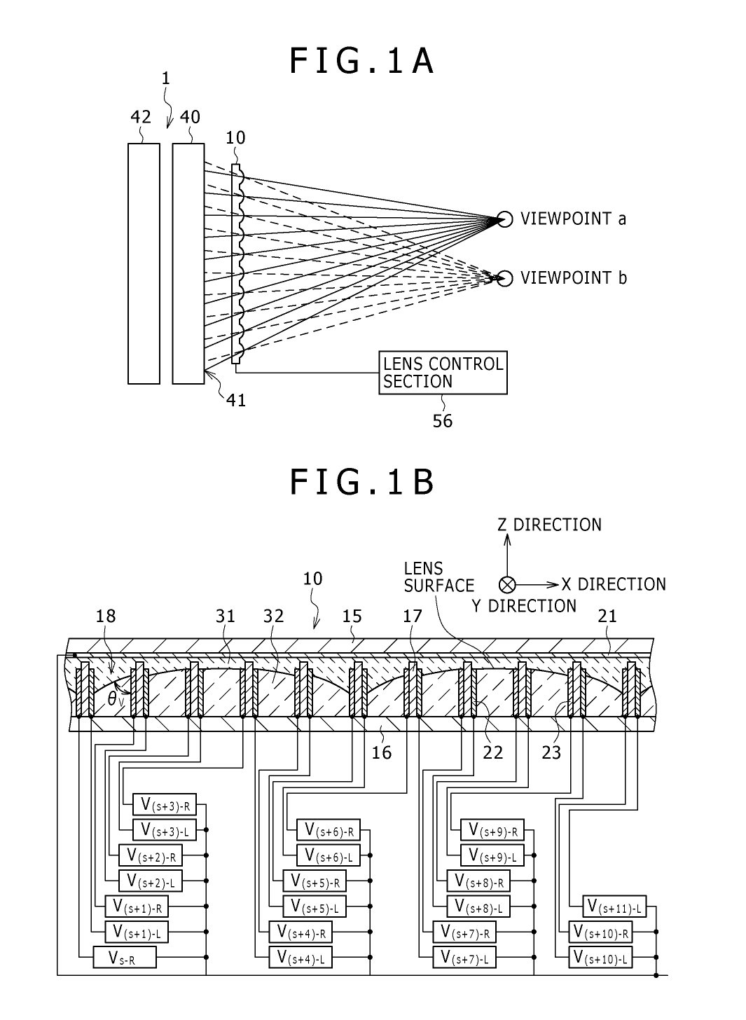

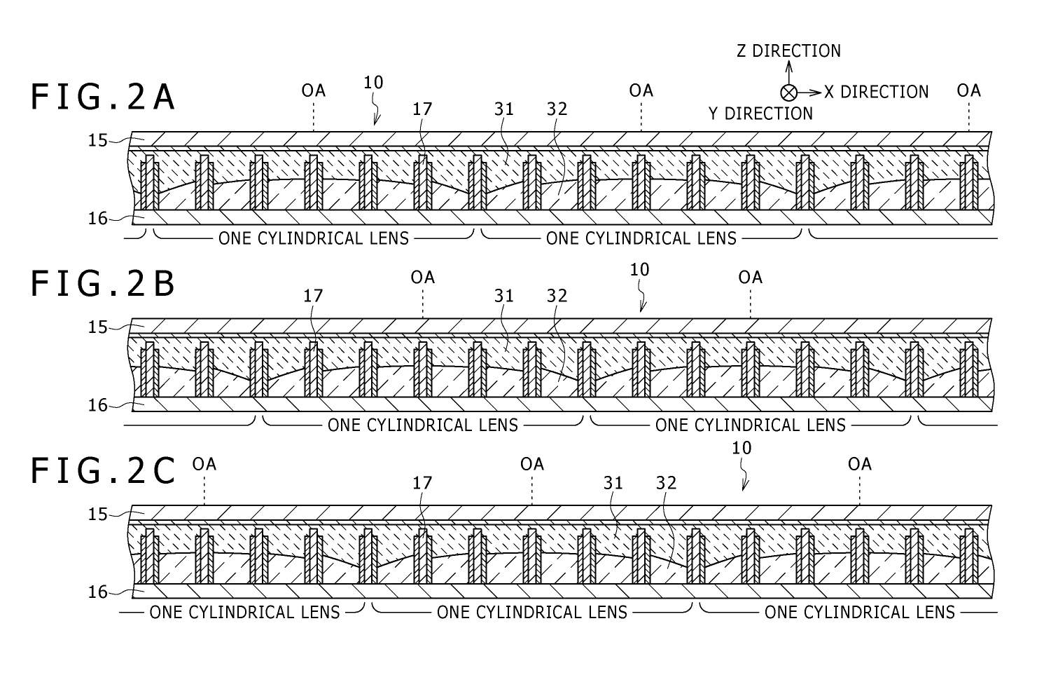

Embodiment 1 relates to a stereoscopic image display device and driving method of the same. FIG. 1A illustrates a conceptual diagram of the stereoscopic image display device according to embodiment 1. FIGS. 1B and 2A to 2C illustrate schematic partial cross-sectional views of the lenticular lens section. It should be noted that although the lenticular lens section 10 is shown in the form of convex or concave lenses for reasons of convenience, the same section is in reality in the form of a flat plate in appearance.

A stereoscopic image display device 1 according to embodiment 1 includes
(A) an image display section 40 having a plurality of pixels 41 arranged in a two-dimensional matrix,
(B) a lenticular lens section 10 made up of a plurality of cylindrical lenses arranged side by side, and
(C) a lens control section 56.

Here, embodiment 1 further includes a light source. The light source, image display section 40 and lenticular lens section 10 are arranged in this order. The image display section 40 includes a liquid crystal display device, and the light source includes a known backlight 42.

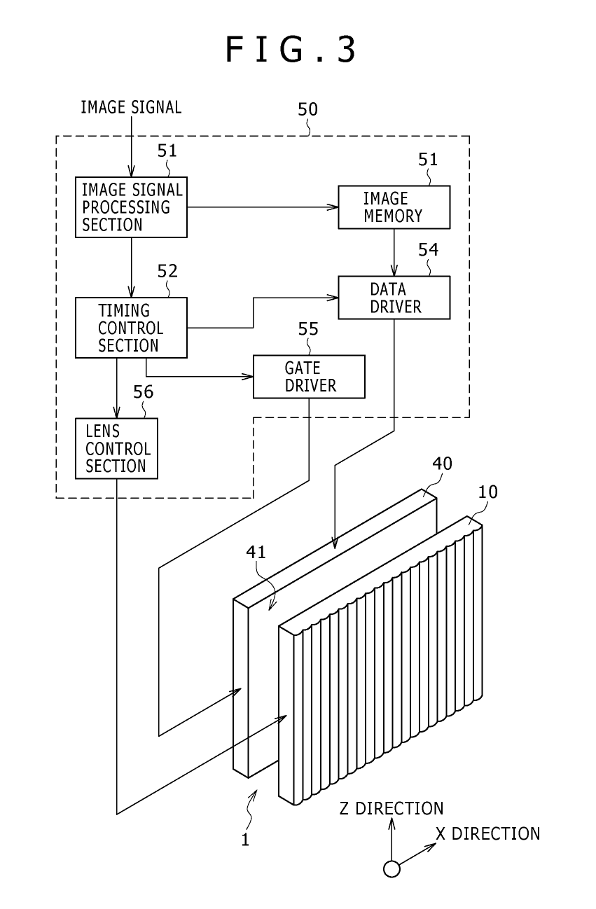

The stereoscopic image display device 1 includes a control circuit 50 shown in FIG. 3. The control circuit 50 includes a data driver 54, gate driver 55, timing control section (timing generator) 52, image signal processing section (signal generator) 51, image memory 53 and lens control section 56. The data driver 54 supplies a drive voltage based on an image signal to the pixels 41 making up the image display section 40. The gate driver 55 sequentially drives the pixels 41 line by line along unshown scan lines. The timing control section 52 controls the data driver 54 and gate driver 55. The image signal processing section 51 processes an externally supplied image signal to generate divided image signals. The image memory 53 is a frame memory adapted to store the divided image signals from the image signal processing section 51.

The image signal processing section 51 divides a piece of externally supplied image data into a given number of (e.g., two or four) pieces of image data (divided image data). That is, the same section 51 divides an image signal making up a piece of image data into image signals making up a given number of image display frames (given number of image signal groups) and sends the image signals to the image memory 53. Further, the image signal processing section 51 supplies given control signals to the timing control section 52 so that the data driver 54, gate driver 55 and lens control section 56 operate in synchronism with switching between image display frames. The lens control section 56 supplies voltages of various levels to electrodes 21, 22 and 23 forming a lens compartment 18 in accordance with the timing control performed by the timing control section 52. It should be noted that these divided image signals may be prepared in advance by capturing the target to be displayed from a variety of angles.

When the direction in which the plurality of (N_{CL}) cylindrical lenses are arranged is assumed to be the X direction, that in which the axial lines of the cylindrical lenses are oriented the Y direction, and that in which the optical axes OA of the cylindrical lenses are oriented the Z direction, the lenticular lens section 10 includes a plurality of (M) lens compartments 18 arranged side by side in the X direction with their axial lines oriented in the Y direction. Each of the cylindrical lenses includes a Fresnel lens made up of the plurality (N_{LC-unit}) of consecutive lens compartments 18. Each of the lens compartments 18 has the electrodes 21, 22 and 23 and is filled (sealed) with first and second liquids 31 and 32 having different refractive indices. Each of the lens compartments 18 forms a liquid lens whose surface, made up of the interface between the first and second liquids 31 and 32, undergoes a change as voltages are applied to the electrodes 21, 22 and 23. The cylindrical lenses serve as convex lenses.

The lens control section 56 controls the application of voltages to the electrodes 21, 22 and 23 in each of the lens compartments 18 so as to move optical axes OA of the cylindrical lenses in the X direction. More specifically, the optical axes OA of the cylindrical lenses are moved in the X direction in synchronism with switching between image frames on the image display section 40. The X direction is assumed to be oriented parallel to the horizontal direction of the image display section. Further, the lenticular lens section 10 and image display section 40 are arranged so that the focal plane of the cylindrical lenses matches the display surface of the image display section 40.

More specifically, we assume, as illustrated in FIG. 1B, that a voltage V_{s-R} is applied to the third electrode 23 of an sth lens compartment 18_{S}, a voltage V_{(s+1)-L} to the second electrode 22 of an (s+1)th lens compartment, a voltage V_{(s+1)-R} to the third electrode 23 of the (s+1)th lens compartment, and so on, and a voltage V_{(s+10)-R} to the third electrode 23 of an (s+10)th lens compartment 18_{(S+10)}, and a voltage V_{(s+11)-L} to the second electrode 22 of an (s+11)th lens compartment. In the condition illustrated in FIG. 1B, the application of voltages to the electrodes 22 and 23 is controlled by the lens control section 56 as shown in Table 1 below. The higher in Table 1, the higher the voltages are in level. By controlling the application of voltages to the electrodes 22 and 23 with the lens control section 56, and more specifically, by changing the voltages applied to the electrodes 22 and 23 each time the image display frames switch, the optical axes OA (shown by dashed lines in FIGS. 2A to 2C) of the cylindrical lenses can be moved in the X direction as illustrated in FIGS. 2A to 2C. In embodiment 1, the electrode 21 is grounded for use as a common electrode.

[Table 1]

V_{(s+1)-R}=V_{(s+5)-L}=V_{(s+6)-R}=V_{(s+10)-L}

V_{(s+2)-R}=V_{(s+4)-L}=V_{(s+7)-R}=V_{(s+9)-L}

V_{(s+3)-L}=V_{(s+3)-R}=V_{(s+8)-L}=V_{(s+8)-R}

V_{(s+2)-L}=V_{(s+4)-R}=V_{(s+7)-L}=V_{(s+9)-R}

V_{(s+1)-L}=V_{(s+5)-R}=V_{(s+6)-L}=V_{(s+10)-R}

The driving method of a stereoscopic image display device according to embodiment 1 uses the stereoscopic image display device 1 according to embodiment 1. The driving method moves the optical axes OA of the cylindrical lenses in the X direction by controlling the application of voltages to the electrodes 21, 22 and 23 in each of the compartments 18 with the lens control section 56. Here, the optical axes OA of the cylindrical lenses are moved in the X direction in synchronism with switching between image frames on the image display section 40.

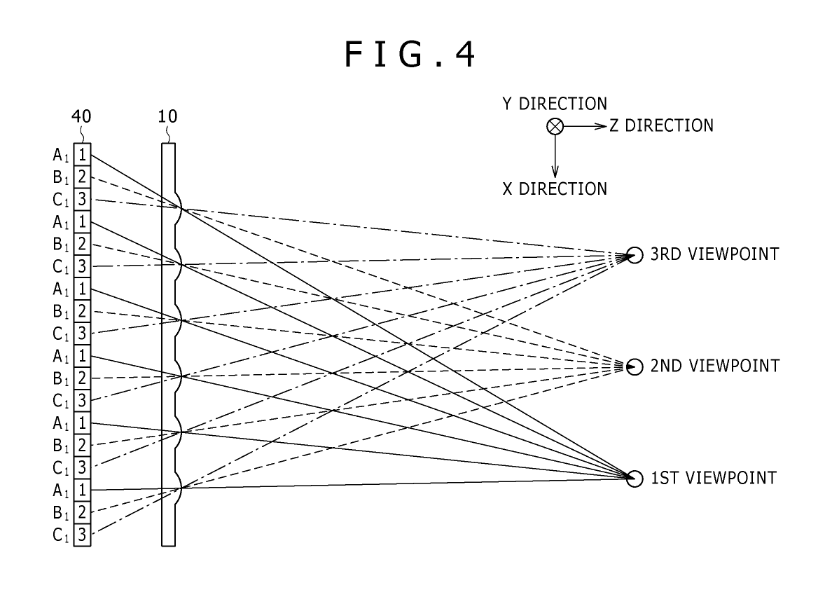

A description will be given below of the kinds of images obtained at different viewpoints when the optical axes OA of the cylindrical lenses making up the lenticular lens section 10 are moved in the X direction in the stereoscopic image display device according to embodiment 1 with reference to FIGS. 4 to 6. These figures show as if there are regions between the cylindrical lenses that do not make up the cylindrical lenses. In reality, however, there are no regions between the cylindrical lenses that do not make up the cylindrical lenses.

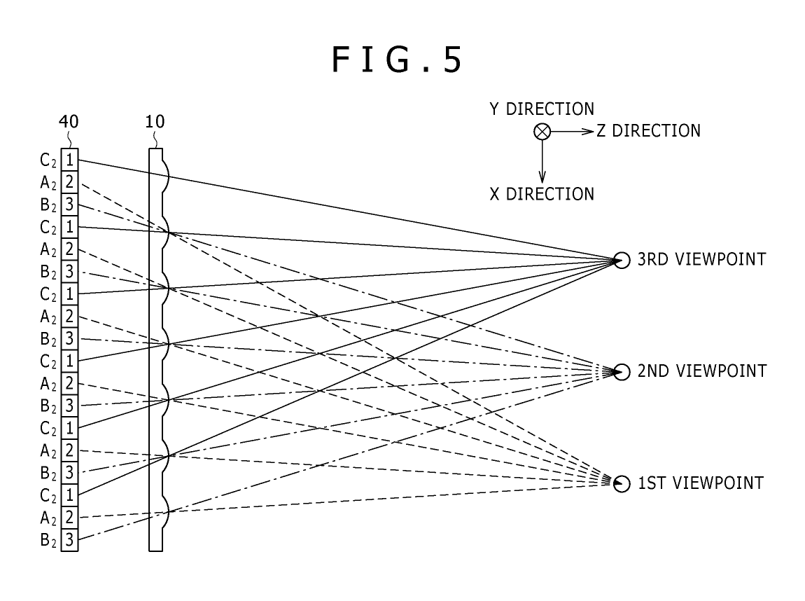

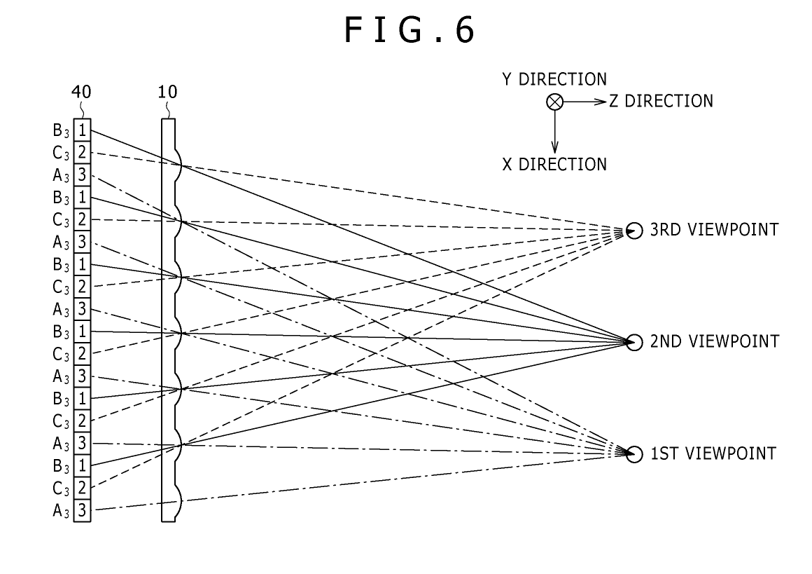

When the N_{POV} different images are displayed on the image display section, each of the images is focused at a single viewpoint by N_{CL} cylindrical lenses. In order to display the N_{POV} different images on the image display section, the pixel subunits are classified into N_{POV} different pixel subunit groups. Although a description will be given here assuming that N_{POV} is three (3), N_{POV} is not limited to three (3). We assume, as illustrated in FIG. 4, that an image “A₁” displayed on a first pixel subunit group [1] (shown by solid lines in FIG. 4) is focused at the first viewpoint by the N_{CL} cylindrical lenses, that an image “B₁” displayed on a second pixel subunit group [2] (shown by dotted lines in FIG. 4) is focused at the second viewpoint by the N_{CL} cylindrical lenses, and that an image “C₁” displayed on a third pixel subunit group [3] (shown by long dashed short dashed lines in FIG. 4) is focused at the third viewpoint by the N_{CL} cylindrical lenses. These images “A₁,” “B₁” and “C₁” are simultaneously displayed on the image display section. Next, the image frames are switched on the image display section. At this time, the optical axes OA of the cylindrical lenses are moved in the X direction in synchronism with switching between image frames on the image display section. Then, as illustrated in FIG. 5, an image “A₂” displayed on the second pixel subunit group [2] (shown by dotted lines in FIG. 5) is focused at the first viewpoint by the N_{CL} cylindrical lenses. An image “B₂” displayed on the third pixel subunit group [3] (shown by long dashed short dashed lines in FIG. 5) is focused at the second viewpoint by the N_{CL} cylindrical lenses. An image “C₂” displayed on the first pixel subunit group [1] (shown by solid lines in FIG. 5) is focused at the third viewpoint by the N_{CL} cylindrical lenses. These images “A₂,” “B₂” and “C₂” are also simultaneously displayed on the image display section. Further, the image frames are switched on the image display section. At this time, the optical axes OA of the cylindrical lenses are similarly moved in the X direction in synchronism with switching between image frames on the image display section. Then, as illustrated in FIG. 6, an image “A₃” displayed on the third pixel subunit group [3] (shown by long dashed short dashed lines in FIG. 6) is focused at the first viewpoint by the N_{CL} cylindrical lenses. An image “B₃” displayed on the first pixel subunit group [1] (shown by solid lines in FIG. 6) is focused at the second viewpoint by the N_{CL} cylindrical lenses. An image “C₃” displayed on the second pixel subunit group [2] (shown by dotted lines in FIG. 6) is focused at the third viewpoint by the N_{CL} cylindrical lenses. These images “A₃,” “B₃” and “C₃” are also simultaneously displayed on the image display section. On the other hand, the images “A₁,” “A₂” and “A₃” are the same images produced from the single piece of image data “A₀.” Similarly, the images “B₁,” “B₂” and “B₃” are the same images produced from the single piece of image data “B₀,” and the images “C₁,” “C₂” and “C₃” are the same images produced from the single piece of image data “C₀.” That is, a single piece of image data is spatially displayed on the N_{POV} different pixels 41.

As described above, a single piece of image data is divided in time into a given number (e.g., two or four) of pieces of image data (divided image data). An image is sequentially displayed on the first, second, third pixel subunit groups [1], [2] and [3], all the way to N_{POV}th pixel subunit group [N_{POV}] by a given number of image frames. That is, a single spatial piece of image data is displayed over the entire image display section. This contributes to higher apparent resolution of the image display section, thus solving the problem of reduced resolution of the stereoscopic image caused by the increased number of viewpoints.

That is, in the stereoscopic image display device 1, the data driver 54 and gate driver 55 supply a drive voltage (pixel application voltage) to (unshown) pixel electrodes of the pixels 41 based on divided image signals supplied from the image signal processing section 51. More specifically, the gate driver 55 applies a pulse voltage to gate electrodes of TFT elements in a row of the image display section 40. At the same time, the data driver 54 applies a pixel application voltage based on the divided image signals to the pixel electrodes in the row. This modulates the light emitted from the backlight with an unshown liquid crystal layer, causing light making up the image (display image light) to be emitted from each of the pixels 41 of the image display section 40 and producing a two-dimensional display image. The display image light emitted from the image display section 40 passes through the lenticular lens section 10. At this time, in order to move the optical axes OA of the cylindrical lenses in the X direction based on the control signal supplied from the lens control section 56, the application of voltages to the electrodes 21, 22 and 23 in each of the lens compartments 18 is controlled. As a result, each time divided image signals are switched for each image display frame, the direction in which the display image light is emitted from the pixels 41 changes. Here, the display image light contains information about binocular parallax and vergence angle. Because proper display image light is emitted according to the distance from the image observer to the image display section, a desired stereoscopic image is displayed according to the distance from the image observer to the image display section.

As described above, in the stereoscopic image display device 1 or driving method of the same according to embodiment 1, the lens control section 56 controls the application of voltages to the electrodes 21, 22 and 23 in each of the lens compartments 18 to move the optical axes OA of the cylindrical lenses in the X direction. Further, the optical axes OA of the cylindrical lenses are moved in the X direction as the lens control section 56 controls the application of voltages to the electrodes 21, 22 and 23 in each of the lens compartments. As described above, moving the optical axes OA of the cylindrical lenses in the X direction contributes to higher apparent resolution of the image display section 40, thus solving the problem of reduced resolution of the stereoscopic image caused by the increased number of viewpoints N_{POV}. The increased number of viewpoints N_{POV} permits observation of a stereoscopic image in a large spatial region. On the other hand, the movement of the optical axes OA of the cylindrical lenses in the X direction is based on the action of liquid lenses and is not achieved by using any mechanical means. As a result, the movement can be controlled at high speed, thus permitting application to a large-area stereoscopic image display device.

When one observes a stereoscopic image with a stereoscopic image display device, there may be a spatial region in a pseudoscopic condition, adversely affecting the visual perception of the screen as a whole. The term “pseudoscopic condition” refers to a phenomenon in which the image that should originally be visually perceived by the left eye of the image observer finds its way into the right eye, and the image that should originally be visually perceived by the right eye of the image observer finds its way into the left eye. That is, when the image observer can view the left and right images orthoscopically, he or she can perceive a stereoscopic image. However, if the image observer is at a pseudoscopic position where the left and right images are inverted, he or she cannot properly perceive a stereoscopic image. Therefore, if a pseudoscopic condition takes place, the image observer must move to a position where he or she can perceive a stereoscopic image properly. A technique called head tracking is discussed for a stereoscopic image display device in related art as a solution to a pseudoscopic condition. This technique moves the pseudoscopic position by means of manipulation on the stereoscopic image display device to display the images so that the observer can always view the images at an orthoscopical position. However, highly accurate adjustment of viewing area has not been achieved to date.

Embodiment 1 can move the spatial region in a pseudoscopic condition by moving the optical axes OA of the cylindrical lenses in the X direction, thus permitting highly accurate adjustment of viewing area and avoiding a pseudoscopic position for a larger observation position. This basically eliminates the need for the image observer to move to a position where he or she can properly perceive a stereoscopic image. It should be noted that if the stereoscopic image display device has a position measuring section 57 described in embodiment 5 which will be described later that is adapted to measure the position of the image observer, the pseudoscopic position can be moved away from the spatial region where the image observer is located.

A description will be given below of the lens compartments and other components making up the lenticular lens section 10.

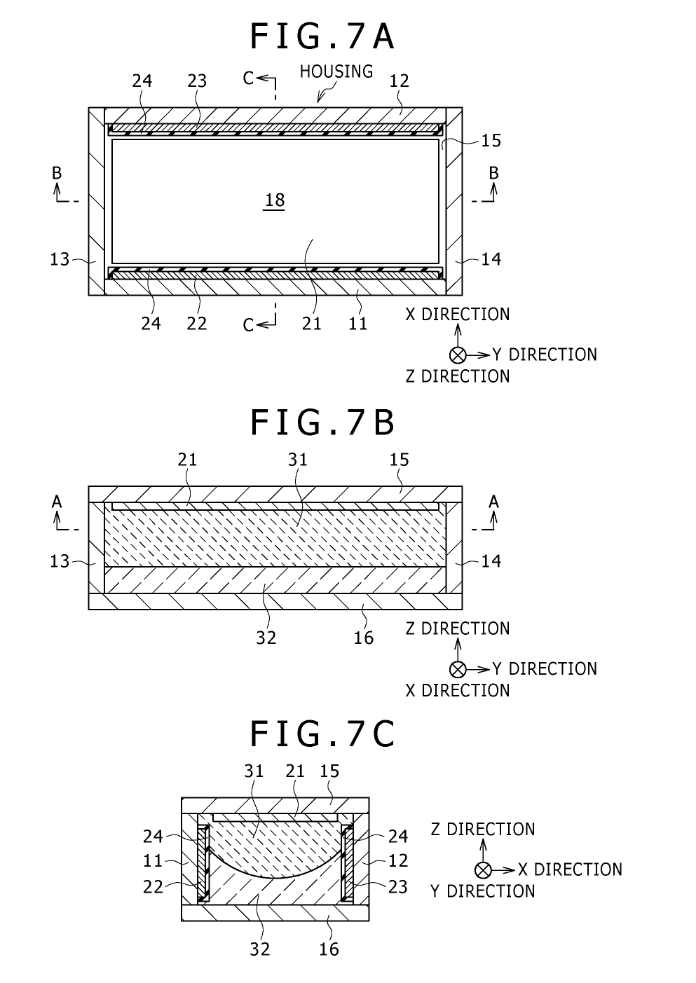

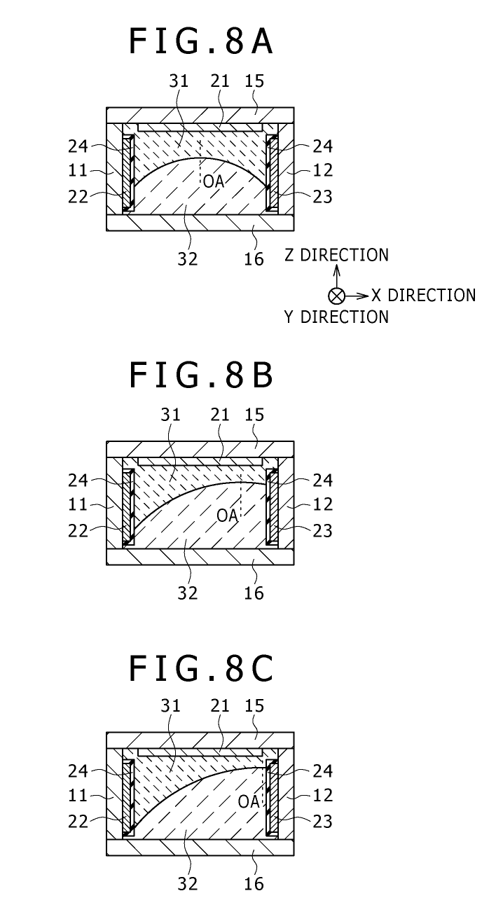

The M lens compartment structure lenticular lens section 10 includes a housing. FIGS. 7A to 7C schematically illustrate a housing making up the lens compartment 18 assuming that the lenticular lens section 10 includes the single lens compartment 18. Here, FIG. 7A is a schematic cross-sectional view taken along arrow A-A in FIG. 7B, FIG. 7B a schematic cross-sectional view taken along arrow B-B in FIG. 7A (first liquid not shown), and FIG. 7C and FIGS. 8A to 8C are schematic cross-sectional views taken along arrow C-C in FIG. 7A. The shape of the liquid lens when cut along the XZ plane is schematic and differs from the actual shape.

The housing includes first, second, third and fourth side members 11, 12, 13 and 14. The second side member 12 is opposed to the first side member 11. The third side member 13 connects one end portion of the first side member 11 and one end portion of the second side member 12. The fourth side member 14 connects the other end portion of the first side member 11 and the other end portion of the second side member 12.

The housing further includes a ceiling plate 15 attached to the top surfaces of the first, second, third and fourth side members 11, 12, 13 and 14.

The housing still further includes a bottom plate 16 attached to the bottom surfaces of the first, second, third and fourth side members 11, 12, 13 and 14.

The lens compartment is filled with the first and second liquids 31 and 32. The first and second liquids 31 and 32 form a liquid lens serving as a cylindrical lens whose axial line extends in the direction (Y direction) in which the first and second side members 11 and 12 extend.

The first electrode 21 is provided on the inner surface of the ceiling plate 15. The second electrode 22 is provided on the inner surface of the first side member 11. The third electrode 23 is provided on the inner surface of the second side member 12. Here, no voltages are applied to the first, second and third electrodes 21, 22 and 23 in the condition shown in FIGS. 7A to 7C.

When proper voltages are applied to the first, second and third electrodes 21, 22 and 23 in the condition, the condition of the interface between the first and second liquids 31 and 32 undergoes a change to the condition shown in FIG. 8A, 8B or 8C. Here, FIG. 8A illustrates a condition in which the same voltage is applied to the second and third electrodes 22 and 23. The shape of the liquid lens formed in the lens compartment when cut along the XZ plane is symmetrical with respect to the optical axis OA. On the other hand, FIGS. 8B and 8C illustrate a condition in which different voltages are applied to the second and third electrodes 22 and 23. The shape of the liquid lens formed in the lens compartment when cut along the XZ plane is asymmetrical with respect to the optical axis OA. It should be noted that the potential difference between the second and third electrodes 22 and 23 is greater in the condition illustrated in FIG. 8C than in the condition illustrated in FIG. 8B. As illustrated in FIGS. 8B and 8C, the optical power of each lens compartment can be changed according to the potential difference between the second and third electrodes 22 and 23. Further, the optical axis OA of the liquid lens (shown by a dotted line) can be moved in the X direction orthogonal to the Y direction. Still further, a Fresnel lens can be formed by the N_{LC-unit} consecutive lens compartments 18 as a whole.

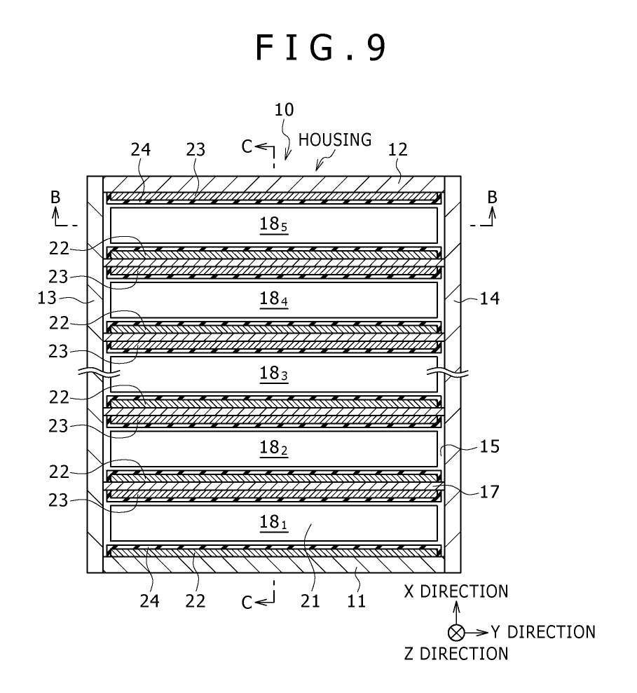

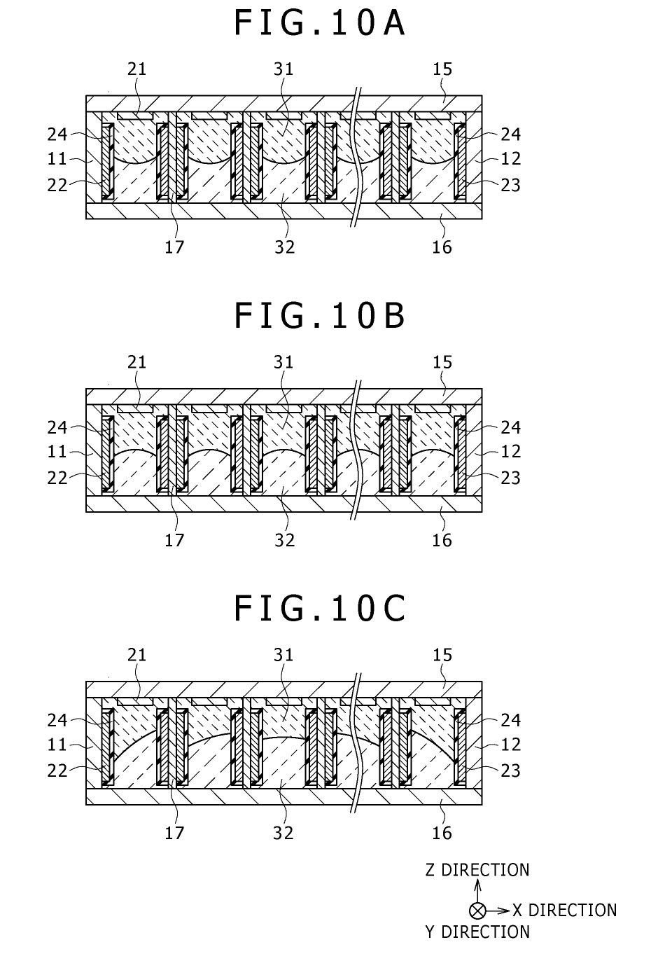

As described above, the M lens compartment structure lenticular lens section 10 is made up of the plurality of lens compartments 18. Here, FIGS. 9 and 10A to 10C illustrate schematic cross-sectional views of the plurality of lens compartments 18. It should be noted that FIG. 9 is a similar schematic cross-sectional view taken along arrow A-A in FIG. 7B, and FIGS. 10A to 10C are schematic cross-sectional views taken along arrow C-C in FIG. 9. It should be noted that the schematic cross-sectional view taken along arrow B-B shown in FIG. 9 is similar to that shown in FIG. 7B. The M lens compartment structure lenticular lens section described above has the Ath configuration.

The M lens compartment structure lenticular lens section 10 having the Ath configuration includes
(A) a housing, and
(B) (M−1) partition wall members 17.

The housing includes the first, second, third and fourth side members 11, 12, 13 and 14. The second side member 12 is opposed to the first side member 11. The third side member 13 connects one end portion of the first side member 11 and one end portion of the second side member 12. The fourth side member 14 connects the other end portion of the first side member 11 and the other end portion of the second side member 12.

The housing further includes a ceiling plate 15 attached to the top surfaces of the first, second, third and fourth side members 11, 12, 13 and 14.

The housing still further includes a bottom plate 16 attached to the bottom surfaces of the first, second, third and fourth side members 11, 12, 13 and 14.

The (M−1) partition wall members 17 are arranged parallel to each other between the first and second side members 11 and 12.

Here, in the example illustrated, the lens compartments 18 (18₁, 18₂, 18₃, 18₄ and 18₅) are arranged side by side merely for simplification of illustration. Each of the lens compartments 18 (18₁, 18₂, 18₃, 18₄ and 18₅) is filled with the first and second liquids 31 and 32. The first and second liquids 31 and 32 form a liquid lens serving as a cylindrical lens whose axial line extends parallel to the direction (Y direction) in which the partition wall members 17 extend.

The first lens compartment 18₁ includes the first and third side members 11 and 13, first partition wall member 17, fourth side member 14, ceiling plate 15 and bottom plate 16. The first electrode 21 is provided on the inner surface of the ceiling plate 15 making up the lens compartment 18₁. The second electrode 22 is provided on the inner surface of the first side member 11 making up the lens compartment 18₁. The third electrode 23 is provided on the inner surface of the partition wall member 17 making up the lens compartment 18₁.

Further, the (m+1)th lens compartment 18₍ₘ₊₁₎ includes the mth (where m=1, 2, . . . M−2) partition wall member 17, third side member 13, (m+1)th partition wall member 17, fourth side member 14, ceiling plate 15 and bottom plate 16. The first electrode 21 is provided on the inner surface of the ceiling plate 15 making up the (m+1)th lens compartment 18₍ₘ₊₁₎. The second electrode 22 is provided on the inner surface of the mth partition wall member 17 making up the (m+1)th lens compartment 18₍ₘ₊₁₎. The third electrode 23 is provided on the inner surface of the (m+1)th partition wall member 17 making up the (m+1)th lens compartment 18₍ₘ₊₁₎.

Still further, the Mth lens compartment 18_{M} (=18₅) includes the (M−1)th partition wall member 17, third side member 13, second side member 12, fourth side member 14, ceiling plate 15 and bottom plate 16. The first electrode 21 is provided on the inner surface of the ceiling plate 15 making up the Mth lens compartment 18_{M}. The second electrode 22 is provided on the inner surface of the (M−1)th partition wall member 17 making up the Mth lens compartment 18_{M}. The third electrode 23 is provided on the inner surface of the second side member 12 making up the Mth lens compartment 18_{M}.

It should be noted that although, in the example illustrated, the first electrode 21 is provided in each of the lens compartments, the single first electrode 21 may be provided on the inner surface of the ceiling plate 15 as illustrated in FIGS. 1A and 1B or 2A to 2C.

In the M lens compartment structure lenticular lens section 10 having the Ath configuration, the surfaces of at least the first and second side members 11 and 12 and partition wall members 17, where the interfaces between the first and second liquids 31 and 32 are located, are treated to be water-repellent. On the other hand, although FIGS. 1A and 1B or 2A to 2C show as if there is a gap between the top surfaces of the partition wall members 17 and the ceiling plate 15, the bottom surfaces of the same members 17 extend to the bottom plate 16 and the top surfaces thereof to the ceiling plate 15. The housing is rectangular in appearance. Light enters the lenticular lens section 10 from the bottom plate 16 and leaves the same section 10 from the ceiling plate 15.

In the lenticular lens section according to embodiment 1 or any one of embodiments 2 to 7 which will be described later, the first and second liquids 31 and 32 are insoluble and immiscible with each other. The interfaces between the first and second liquids 31 and 32 make up a lens surface. Here, the first liquid 31 is conductive, and the second liquid 32 insulating. The first electrode 21 is in contact with the first liquid 31. The second electrode 22 is in contact with the first and second liquids 31 and 32 via an insulating film 24. The third electrode 23 is in contact with the first and second liquids 31 and 32 via the insulating film 24. On the other hand, the ceiling and bottom plates 15 and 16 and first electrode 21 are made of a material transparent to light incident upon the lenticular lens section 10.

More specifically, the ceiling plate 15, bottom plate 16, first, second, third and fourth side members 11, 12, 13 and 14, and partition wall members 17 are made of glass or a resin such as acryl-based resin. The conductive first liquid 31 is made of an aqueous solution of lithium chloride, with a density of 1.06 g/cm³ and a refractive index of 1.34. On the other hand, the insulating second liquid 32 is made of silicone oil (TSF437 manufactured by Momentive Performance Materials Japan LLC (former GE Toshiba Silicone)), with a density of 1.02 g/cm³ and a refractive index of 1.49. The first electrode 21 is made of ITO, and the second and third electrodes 22 and 23 are made, for example, of a metal such as gold, aluminum, copper and silver. The insulating film 24 is made of a metal oxide such as polyparaxylene, tantalum oxide and titanium oxide. It should be noted that a water-repellent treated layer (not shown) is provided on top of the insulating film 24. The water-repellent treated layer is made of polyparaxylene or fluorine-based polymer. The surface of the first electrode 21 and the inner surfaces of the third and fourth side members 13 and 14 should preferably be treated to be water-repellent. The above may also be true for the lenticular lens section according to embodiments 2 to 7 which will be described later unless otherwise specified.

The first, second and third electrodes 21, 22 and 23 are connected to the lens control section 56 via an unshown connection portion so that desired voltages are applied thereto. When voltages are applied to the first, second and third electrodes 21, 22 and 23, the lens surface made up of the interfaces between the first and second liquids 31 and 32 undergoes a change from a downwardly convex condition illustrated in FIG. 10A to an upwardly convex condition illustrated in FIG. 10B. The lens surface changes according to the voltages applied to the electrodes 21, 22 and 23 (refer to Equation A). In the example shown in FIG. 10B, the same voltage is applied to the second and third electrodes 22 and 23. Therefore, the shape of the liquid lens formed in the lens compartment when cut along the XZ plane is symmetrical with respect to the optical axis of the liquid lens. On the other hand, FIG. 10C illustrates the condition when different voltages are applied to the second and third electrodes 22 and 23. In this case, a Fresnel lens is formed. Further, the optical axis of the lenticular lens section 10 as a whole can be moved. Moreover, the optical power of each lens compartment can be changed according to the potential difference between the second and third electrodes 22 and 23. It should be noted that when the Fresnel lens delivers optical power with voltages applied to the first, second and third electrodes 21, 22 and 23, the optical power of the same lens is substantially zero in the YZ plane (or plane parallel to the YZ plane). The optical power of the same lens in the XZ plane has a finite value. Here, the term “optical axis of the Fresnel lens” refers to a line connecting the curvature centers of two virtual optical surfaces of a virtual lens obtained by the Fresnel lens as a whole (single lens obtained by the Fresnel lens as a whole) when the same lens is cut along the XZ plane.

The above basic operation of the lenticular lens section 10 according to embodiment 1 is the same for the lenticular lens section according to embodiments 2 to 7 which will be described later.

### Embodiment 2

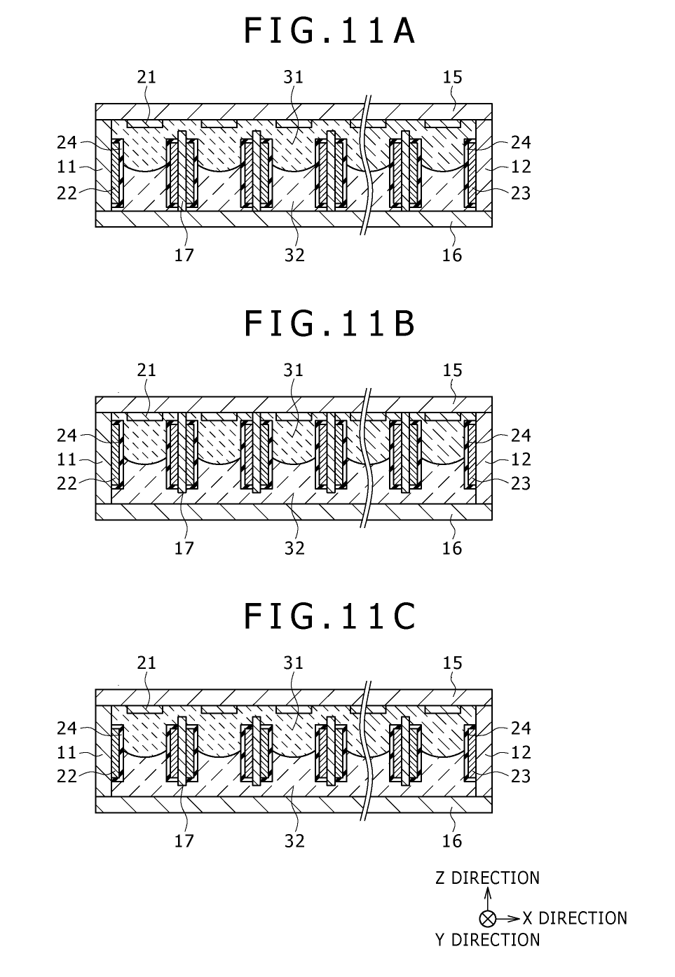

Embodiment 2 is a modification of embodiment 1 and relates to the Bth configuration. As illustrated in a schematic cross-sectional view in FIG. 11A, the bottom surfaces of the partition wall members 17 extend to the bottom plate 16, with a gap provided between the top surfaces of the same members 17 and the ceiling plate 15 in the M lens compartment structure lenticular lens section 10. It should be noted that FIG. 11A, and FIGS. 11B and 11C, which will be described later, are similar schematic cross-sectional views taken along arrow C-C in FIG. 9. Except in this respect, the stereoscopic image display device according to embodiment 2 can be configured and structured in the same manner as that according to embodiment 1. Therefore, the detailed description thereof is omitted.

### Embodiment 3

Embodiment 3 is also a modification of embodiment 1 and relates to the Cth configuration. As illustrated in a schematic cross-sectional view in FIG. 11B, a gap is provided between the bottom surfaces of the partition wall members 17 and the bottom plate 16, and the top surfaces of the same members 17 extend to the ceiling plate 15 in the M lens compartment structure lenticular lens section according to embodiment 3. Except in this respect, the stereoscopic image display device according to embodiment 3 can be configured and structured in the same manner as that according to embodiment 1. Therefore, the detailed description thereof is omitted.

### Embodiment 4

Embodiment 4 is also a modification of embodiment 1 and relates to the Dth configuration. As illustrated in a schematic cross-sectional view in FIG. 11C, a gap is provided between the bottom surfaces of the partition wall members 17 and the bottom plate 16, and a gap is also provided between the top surfaces of the same members 17 and the ceiling plate 15 in the M lens compartment structure lenticular lens section according to embodiment 4. Except in this respect, the stereoscopic image display device according to embodiment 4 can be configured and structured in the same manner as that according to embodiment 1. Therefore, the detailed description thereof is omitted.

The lenticular lens section described in embodiment 4 can be fabricated, for example, as described below.

First, the first, second, third and fourth side members 11, 12, 13 and 14, ceiling plate 15, bottom plate 16 and partition wall members 17 are fabricated. It should be noted that an injection port adapted to inject the liquids and a discharge port adapted to discharge the liquids are provided as appropriate on the second and fourth side members 12 and 14. Then, the first, second, third and fourth side members 11, 12, 13 and 14, bottom plate 16 and partition wall members 17 are assembled together using, for example, an adhesive. Next, the second and third electrodes 22 and 23 are formed on the first and third side members 11 and 13 and partition wall members 17 based, for example, on sputtering or plating. On the other hand, the first electrode 21 is formed in advance on the ceiling plate 15 based, for example, on sputtering or plating. Then, the ceiling plate 15 is fastened to the side members 11, 12, 13 and 14.

Next, the second liquid 32 is injected from the injection port (not shown) provided on the second side member 12 first, followed by the first liquid 31, while at the same time depressurizing the lens compartments 18. At this time, the first liquid 31 is injected while at the same time forming an interface with the second liquid 32. Part of the second liquid 32 is discharged from the discharge port (not shown). Finally, the injection and discharge ports are sealed, and the electrodes connected to the lens control section 56 to complete the lenticular lens section.

It should be noted that the lenticular lens sections described in other embodiments can be substantially fabricated in the same manner.

### Embodiment 5

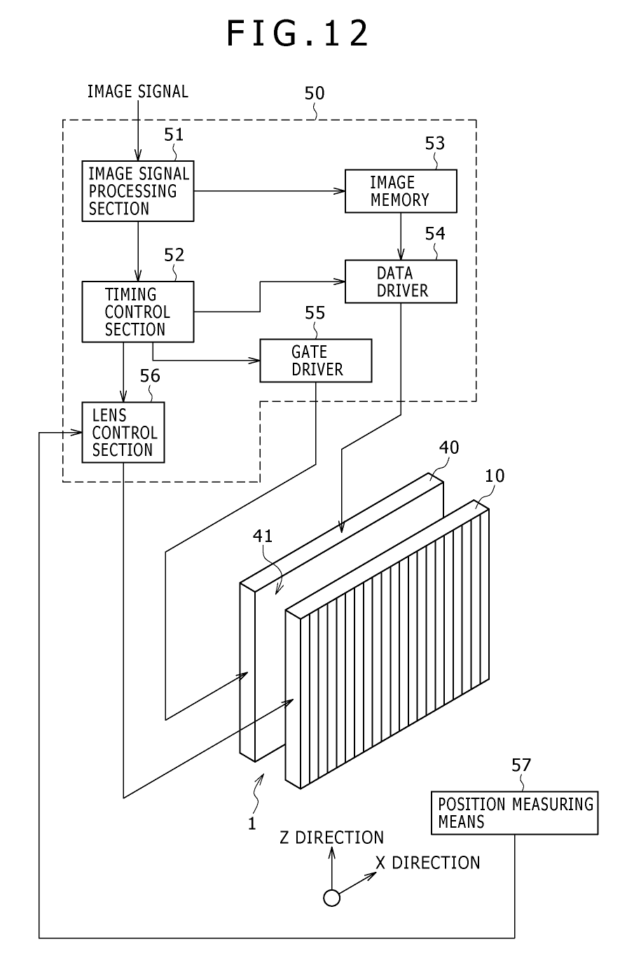

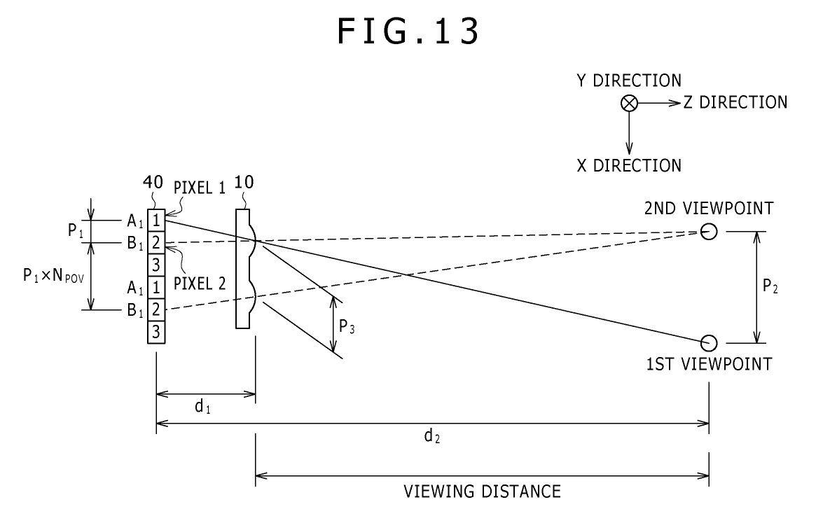

Embodiment 5 is a modification of embodiments 1 to 4. In the stereoscopic image display device according to embodiment 5, the application of voltages to the electrodes is controlled in each of the lens compartments to change the arrangement pitch of the cylindrical lenses. Here, the viewing distance, i.e., the distance from the image observer to the image display section, can be changed by changing the arrangement pitch of the cylindrical lenses. FIG. 13 is a schematic diagram for describing the relationship between a pixel pitch, viewpoint-to-viewpoint distance and cylindrical lens pitch in the stereoscopic image display device according to embodiment 5. FIG. 12 is a block diagram illustrating the overall configuration of the stereoscopic image display device according to embodiment 5.

We suppose two pixels, one included in the first pixel subunit group [1] (referred to as a “pixel-1”) and another included in the second pixel subunit group [2] (referred to as a “pixel-2”). Here, we assume that the pixel-1 and pixel-2 are arranged adjacent to each other in the image display section so that the image obtained by the pixel-1 (one kind, dotted image) and that obtained by the pixel-2 (one kind, dotted image) are adjacent to each other. As illustrated in FIG. 13, the distance between the pixel-1 and pixel-2 (pitch between the pixel-1 and pixel-2) is denoted by “P₁.” Further, the distance from the image display section 40 to the lenticular lens section 10 is denoted by d₁, the distance between the first and second viewpoints (viewpoint-to-viewpoint distance) by P₂, the distance from the image display section 40 to a virtual plane containing the two viewpoints by d₂, and the pitch between the adjacent cylindrical lenses (spatial frequency in the arrangement of the cylindrical lenses) by P₃. From FIG. 13, the relationship between P₁, P₂, P₃, dᵢ and d₂ is as shown by Equations 1 and 2 below.

d₂=(P₁+P₂)d₁/P₁ (1)

P₃={(d₂−d₁)d₂}N_{POV}·P₁ (2)

The following Equations 3 and 4 are derived from Equations 1 and 2:

d₂=N_{POV}·P₁·d₁/(N_{POV}·P₁−P₃) (3)

P₂=P₁·P₃/(N_{POV}·P₁=P₃) (4)

Incidentally, a stereoscopic image display device in related art cannot, in general, change the distance d₂ determined by the pitch P₃ of the lenticular lens section (refer to Equation 3 above). Therefore, the stereoscopic image display device is designed after having determined in advance the viewing distance (d₂−d₁) by assuming a room of specific size. As a result, if the image observer observes an image at a position outside the assumed distance (d₂−d₁), the perception of a stereoscopic image may be adversely affected. That is, a variety of models are required according to the size of the room where an image is to be observed. This is problematic when volume production is considered.

From Equation 3, if the set pitch P₃ between the adjacent cylindrical lenses can be changed, then d₂, i.e., the viewing distance (d₂−d₁), can be changed. This eliminates the need for a variety of models according to the size of the room where an image is to be observed. Thus, even if the position of the image observer changes, that is, even if the distance d₂ changes, the stereoscopic image display device according to embodiment 5 can change the pitch P₃ between the adjacent cylindrical lenses. This ensures that the observation of a stereoscopic image by the image observer is not hindered. It should be noted that it is only necessary to change the voltages applied to the electrodes 21, 22 and 23 properly with the lens control section 56 in order to change the pitch P₃ between the adjacent cylindrical lenses.

The stereoscopic image display device according to embodiment 5 further includes the position measuring section 57 adapted to measure the position of the image observer, thus controlling the application of voltages to the electrodes in each of the lens compartments based on the position information of the image observer obtained by the same section 57. As illustrated in FIG. 12, among devices that can be used as the position measuring section 57 are video camcorder or web camera having a solid-state imaging element capable of capturing still or moving images and infrared position measuring device. In response to the output from the position measuring section 57, the lens control section 56 need only determine the position of the image observer by a publicly known method and control the voltages applied to the electrodes 21, 22 and 23 in each of the lens compartments 18 as described above based on the position information of the image observer.

Alternatively, the stereoscopic image display device may have switches or other controls used to enter the approximate position of the image observer (distance from the stereoscopic image display device to the image observer) such as “1m,” “2m” or “3m.” In this case, the lens control section 56 checks which switch was operated so as to control the voltages applied to the electrodes 21, 22 and 23 in each of the lens compartments 18.

Except in this respect, the stereoscopic image display device according to embodiment 5 can be configured and structured in the same manner as that according to embodiment 1. Therefore, the detailed description thereof is omitted.

### Embodiment 6

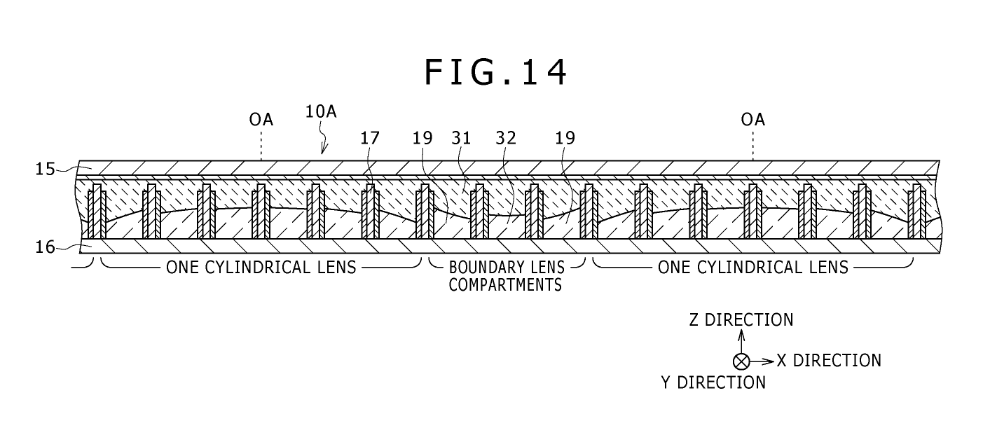

Embodiment 6 is a modification of embodiments 1 to 5. FIG. 14 illustrates a conceptual diagram of a lenticular lens section 10A. In embodiment 6, boundary lens compartments 19 are provided between the cylindrical lenses. The boundary lens compartments 19 have optical power opposite in sign to that of the cylindrical lenses. More specifically, the cylindrical lenses serve as convex lenses, and the lens formed by the boundary lens compartments 19 serves as a concave lens.

Except in this respect, the stereoscopic image display device according to embodiment 6 can be configured and structured in the same manner as that according to embodiment 1. Therefore, the detailed description thereof is omitted. In embodiment 6, light passing through the boundary lens compartments 19 does not reach the image observer, thus making it difficult for the image observer to visually perceive the boundary region between the cylindrical lenses and thereby providing improved quality of the displayed stereoscopic image.

### Embodiment 7

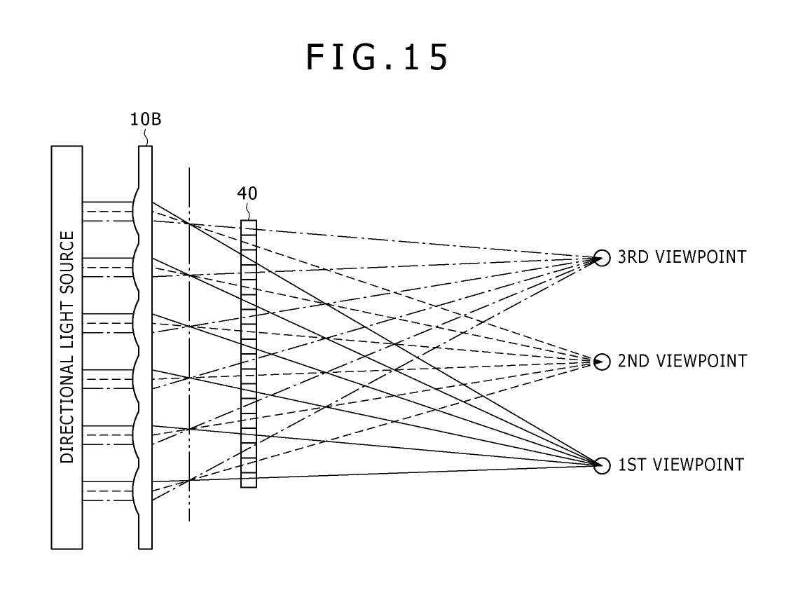

Embodiment 7 is a modification of embodiments 1 to 6. As illustrated in a conceptual diagram for describing the arrangement of the lenticular lens section, image display section and other components of the stereoscopic image display device in FIG. 15, the light source, lenticular lens section 10B and image display section 40 are arranged in this order in embodiment 7. Further, the cylindrical lenses serve as convex lenses in a lenticular lens section 10B. Light beams from the directional light source, i.e., parallel light beams emitted from the light source, pass through the lenticular lens section 10B, entering the image display section 40. In FIG. 15, the focal plane of the cylindrical lenses is shown by a long dashed short dashed line. The lenticular lens section 10B and image display section 40 are arranged so that the distance from the cylindrical lenses to the display surface of the image display section is twice the focal distance of the cylindrical lenses.

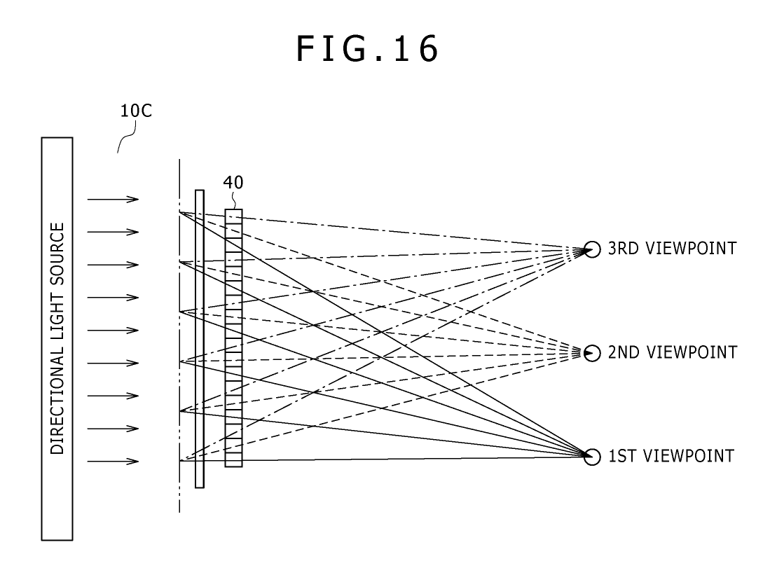

Alternatively, as illustrated in a conceptual diagram for describing the arrangement of the lenticular lens section, image display section and other components of the stereoscopic image display device in FIG. 16, the cylindrical lenses may serve as concave lenses in a lenticular lens section 10C. Light beams from the directional light source, i.e., parallel light beams emitted from the light source, pass through the lenticular lens section 10C, entering the image display section 40. In FIG. 16, the focal plane of the cylindrical lenses is shown by a long dashed short dashed line. The lenticular lens section 10C and image display section 40 are arranged so that the distance from the cylindrical lenses to the display surface of the image display section matches the focal distance of the cylindrical lenses.

The configurations and structures of the stereoscopic image display device and lenticular lens section are merely illustrative, and the materials making up the lenticular lens section and others are also illustrative. They may be changed as appropriate. Further, the configurations, structures, arrangements and other features of the first, second and third electrodes may also be changed as appropriate according to the properties (electrical conductivity and insulation) of the liquids in direct contact with the liquids or in contact therewith via an insulating film. The viewpoint positions may be changed by moving the optical axes of the cylindrical lenses making up the lenticular lens section in the X direction. In order to do so, the stereoscopic image display device may have switches or other controls used to enter the approximate position of the image observer such as “front of the stereoscopic image display device,” “0.5 m to the right from the front of the stereoscopic image display device” or “0.5 m to the left from the front of the stereoscopic image display device.” The lens control section 56 checks which switch was operated so as to control the voltages applied to the electrodes 21, 22 and 23 in each of the lens compartments 18 as described above. The viewpoint positions may be changed by controlling the application of voltages to the electrodes in each of the lens compartments based on the position information of the image observer obtained from the position measuring section 57. Alternatively, the voltages applied to the electrodes 21, 22 and 23 in each of the lens compartments 18 may be controlled with the lens control section 56 as the image observer adjusts the viewing distance and viewpoint positions by manipulating the appropriate switches while at the same time observing the image displayed on the stereoscopic image display device. On the other hand, although cases have been described with the embodiments in which a moving image is displayed on the stereoscopic image display device, a still image may be displayed on the stereoscopic image display device. In the embodiments, the image display section includes a liquid crystal display device. However, the same section may include a self-luminous image display device, and more particularly, an organic electroluminescence or plasma display device. The concept of the ceiling and bottom plates in the lenticular lens section is relative. Therefore, the ceiling plate may be interpreted as a first light-transmitting member, and the bottom plate as a second light-transmitting member.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A image display device comprising:
an image display section;
a lenticular lens including a plurality of lenses arranged in a linear array, each lens being defined by a plurality of adjacent variable lenses having a common optical axis; and
a controller that controls optical characteristics in a plurality of the variable lenses such that the common optical axis for at least one of the lenses is moved in a given direction.

2. The image display device according to claim 1, wherein each of the variable lenses are liquid lenses.

3. The image display device according to claim 1, wherein each lens is a fresnel lens.

4. The image display device according to claim 1, wherein the controller changes the optical characteristics of the plurality of variable lenses in synchronization with a switching of image frames of the image display section.

5. The image display device according to claim 1, wherein a plurality of different images each displayed by a different pixel subunit group are focused to a plurality of respective viewpoints through a plurality of the lenses arranged in a linear array.

6. The image display device according to claim 1, wherein the controller synchronizes the movement of the common optical axes of a plurality of lenses with a switching of image frames such that:
at a first time, a first image is displayed by a first pixel subunit group through a plurality of lenses located first positions to a first viewpoint, and
at a second time, a second image is displayed by a second pixel subunit group through the lenses located at second positions to the first viewpoint, the second positions of the lenses being shifted relative the first positions.

7. The image display device according to claim 6, wherein the controller synchronizes the movement of the common optical axes of the lenses such that:
at the first time, a third image is displayed by the second pixel subunit group through the lenses located at the first positions to a second viewpoint, and
at the second time, a fourth image is displayed by a third pixel subunit group through the lenses located at the second positions to the second viewpoint.

8. The image display device according to claim 6, wherein the controller synchronizes the movement of the common optical axes of the lenses such that:
at the first time, a fifth image is displayed by a third pixel subunit group through the lenses located at the first position to a third viewpoint, and
at the second time, a sixth image is displayed by the first pixel subunit group through the lenses located at the second position to the third viewpoint.

9. The image display device according to claim 1, wherein an arrangement pitch between lenses is variable.

10. The image display device according to claim 9, wherein the arrangement pitch of the lenses is changed by controlling the application of voltages to a plurality of electrodes included in each of the variable lenses.

11. The image display device according to claim 9, further comprising a position measuring section configured to detect a position of an object relative to the image display section, wherein the controller changes the arrangement pitch of the lenses based on position information of the object obtained from the position measuring section.

12. The image display device according to claim 1, wherein a number of adjacent variable lenses that constitute a lens is variable.

13. The image display device according to claim 1, wherein a boundary lens is provided between adjacent lenses, the boundary lenses each including a plurality of the variable lenses and having an optical power opposite in sign to that of the lenses.

14. The image display device according to claim 1, further comprising a light source, wherein the light source, the image display section, and the lenticular lens are arranged in this order.

15. The image display device according to claim 1, further comprising a light source, wherein the light source, the lenticular lens, and the image display section are arranged in this order.

16. The image display device according to claim 1, wherein each of the variable lenses are liquid lenses having compartments, and adjacent liquid lens compartments are sectioned by partition wall members.

17. The image display device according to claim 16, wherein electrodes are attached to walls in each of the liquid lens compartments.

18. The image display device according to claim 16, wherein a first liquid is common to all of the liquid lens compartments.

19. The image display device according to claim 1, wherein the image display section, the lenticular lens, and the controller cooperate to enable stereoscopic display of the images.

20. The image display device according to claim 1, wherein the image display section, the lenticular lens, and the controller cooperate to enable the display of different images at different viewpoints.

21. A method of displaying images, the method comprising:
displaying images on an image display device;
controlling optical characteristics of a plurality of lenses such that the plurality of lenses form a lenticular lens, each of said lenses having a common optical axis and including a plurality of adjacent variable lenses; and
changing the optical characteristics of a plurality of the variable lenses such that the common optical axis for at least one of the lenses is moved in a given direction.

22. The method of displaying images according to claim 21, wherein each of the variable lenses are liquid lenses.

23. The method of displaying images according to claim 21, wherein each lens is a fresnel lens.

24. The method of displaying images according to claim 21, further comprising changing the optical characteristics of the plurality of variable lenses in synchronization with a switching of image frames of the image display section.

25. The method of displaying images according to claim 21, further comprising focusing a plurality of different images, each displayed by a different pixel subunit group, through a plurality of the lenses arranged in a linear array to a plurality of respective viewpoints.

26. The method of displaying images according to claim 21, further comprising synchronizing the movement of the common optical axes of a plurality of lenses with a switching of image frames such that:
at a first time, a first image is displayed by a first pixel subunit group through a plurality of lenses located first positions to a first viewpoint, and
at a second time, a second image is displayed by a second pixel subunit group through the lenses located at second positions to the first viewpoint, the second positions of the lenses being shifted relative the first positions.

27. The method of displaying images according to claim 26, further comprising synchronizing the movement of the common optical axes of the lenses such that:
at the first time, a third image is displayed by the second pixel subunit group through the lenses located at the first positions to a second viewpoint, and
at the second time, a fourth image is displayed by a third pixel subunit group through the lenses located at the second positions to the second viewpoint.

28. The method of displaying images according to claim 26, further comprising synchronizing the movement of the common optical axes of the lenses such that:
at the first time, a fifth image is displayed by a third pixel subunit group through the lenses located at the first position to a third viewpoint, and
at the second time, a sixth image is displayed by the first pixel subunit group through the lenses located at the second position to the third viewpoint.

29. The method of displaying images according to claim 21, wherein an arrangement pitch between lenses is variable.

30. The method of displaying images according to claim 29, further comprising changing the arrangement pitch of the lenses by controlling the application of voltages to a plurality of electrodes included in each of the variable lenses.

31. The method of displaying images according to claim 29, further comprising detecting a position of an object relative to the image display section, and changing the arrangement pitch of the lenses based on detected position information of the object.

32. The method of displaying images according to claim 21, wherein a number of adjacent variable lenses that constitute a lens is variable.

33. The method of displaying images according to claim 21, wherein a boundary lens is provided between adjacent lenses, the boundary lenses each including a plurality of the variable lenses and having an optical power opposite in sign to that of the lenses.

34. The method of displaying images according to claim 21, further comprising providing a light source, and arranging the light source, the image display section, and the lenticular lens in this order.

35. The method of displaying images according to claim 21, further comprising providing a light source, and arranging the light source, the lenticular lens, and the image display section in this order.

36. The method of displaying images according to claim 21, wherein each of the variable lenses are liquid lenses having compartments, and adjacent liquid lens compartments are sectioned by partition wall members.

37. The method of displaying images according to claim 36, wherein electrodes are attached to walls in each of the liquid lens compartments.

38. The method of displaying images according to claim 36, wherein a first liquid is common to all of the liquid lens compartments.

39. The method of displaying images according to claim 21, wherein displaying the images, and controlling and changing the optical characteristics of the plurality of the variable lenses enable stereoscopic display of the images.

40. The method of displaying images according to claim 21, wherein displaying the images, and controlling and changing the optical characteristics of the plurality of the variable lenses enable the display of different images at different viewpoints.

41. An optical device comprising:
a plurality of variable lenses arranged in a linear array, each lens being defined by a plurality of adjacent variable lenses having a common optical axis; and
a controller that controls optical characteristics in a plurality of the lenses such that the common optical axis for at least one of the lenses is moved in a given direction.

42. A method of controlling an optical device including a plurality of variable lenses, the method comprising:
controlling optical characteristics of a plurality of variable lenses such that a plurality of adjacent variable lenses form a lens having a common optical axis; and
changing the optical characteristics of the plurality of the variable lenses such that the common optical axis of the lens is moved in a given direction.

43. A stereoscopic image display device comprising:
an image display section;
a lenticular lens including a plurality of liquid lenses arranged in a linear array; and
a controller that controls shapes of liquid-liquid interfaces of the liquid lenses such that a first liquid-liquid interface shape is sequentially formed in a plurality of adjacent liquid lenses in a given direction of the linear array,
wherein the liquid-liquid interface shape is sequentially formed in synchronization with a switching of image frames of the image display section.

44. A method of stereoscopically displaying images, the method comprising:
displaying images on an image display device; and
controlling shapes of liquid-liquid interfaces in a plurality of liquid lenses arranged in a linear array to sequentially form a first liquid-liquid interface shape in a plurality of adjacent liquid lenses in a given direction of the linear array,
wherein the liquid-liquid interface shape is sequentially formed in synchronization with a switching of image frames of the image display section.

45. A stereoscopic image display device comprising:
an image display section;
a plurality of liquid lens compartments arranged in a linear array, each liquid lens compartment including
a plurality of walls that contain first and second liquids, the first liquid being immiscible with the second liquid,
first, second and third electrodes positioned on the walls of the compartment; and
a controller for applying, to one of the liquid lens compartments, a first electric potential to the first electrode and a second electric potential to the second electrode to form a shape of an interface between the first and second liquids,
wherein the controller applies electric potentials to first and second electrodes of each of a plurality of different liquid lens compartments in a given direction of the linear array to sequentially form said shape of the interface in said different liquid lens compartments, and
wherein forming said shape of the interface in said different liquid lens compartments is performed in synchronization with a switching of image frames of the image display section.
